(19) United States
(12) Patent Application Publication
(10) Pub. No.: US 2013/0308675 A1
(43) Pub. Date: Nov. 21, 2013

(54) OPTIMUM PLANT CANOPY TEMPERATURE

(71) Applicant: Smartfield, Inc., Lubbock, TX (US)

(72) Inventors: Doug SNEED, Lubbock, TX (US); Joel HOHENBERGER, Lubbock, TX (US); Tommy J. MARTIN, Lubbock, TX (US); Steve M. HAWKINS, Marble Falls, TX (US); Tray JOHNSON, Lubbock, TX (US)

(73) Assignee: Smartfield, Inc., Lubbock, TX (US)

(21) Appl. No.: 13/895,455

(22) Filed: May 16, 2013

Related U.S. Application Data
(60) Provisional application No. 61/649,020, filed on May 18, 2012.

(51) Int. Cl. G01N 25/00

(52) U.S. Cl. CPC G01N 25/00
USPC 374/121

(57) ABSTRACT

An apparatus and method of determining the optimal plant canopy temperature of a plant by measuring chlorophyll a variable fluorescence is described. Leaf samples taken from the plant are placed on a temperature gradient device, exposed to light for an amount of time, and the variable fluorescence emitted from the leaves is measured along with the temperature. Calculations of Fv/Fo over a period of time are used to determine the optimal plant canopy temperature for a plant or a crop. The apparatus and method can be used to compare specific cultivars, to assess the results of plant breeding programs, and to assist in crop management procedures.

### CROSS REFERENCE TO RELATED APPLICATIONS

This application claims the benefit of priority from U.S. provisional patent application Ser. No. 61/649,020, filed May 18, 2012, which is incorporated herein by reference in its entirety.

### FIELD OF THE INVENTION

An apparatus for determining the biological optimum temperature for plant growth is disclosed. The apparatus employs a method of measuring the chlorophyll a variable fluorescence of leaves held at a range of temperatures, and then analyzing the resulting data. All publications cited in this application are herein incorporated by reference.

### BACKGROUND OF THE INVENTION

Optimum plant canopy temperature (herein called OPCT) is the temperature at which a plant operates most efficiently. This temperature is similar to the body temperature of a mammal in which the animal regulates its temperature by metabolic processes. Researchers have found that plants also have an optimum temperature, but plants are capable of surviving at temperatures far from their optimum temperature.

A plant cannot generally warm itself by metabolic processes. A plant can cool itself, however, through the use of transpiration, in which water is moved up through the plant tissues to exit the plant through the leaf tissues. The exit of water through the leaves causes an evaporative cooling process that can lower the temperature of the plant. If the plant has enough water available for this process, and if the environment is not extreme, the plant is able cool itself to its optimum temperature. The actual temperature of a plant, when compared to its biological optimum temperature, is a useful tool in assessing the plant's level of stress, as well as its water availability. There is a need to understand and better quantitate the differences in optimal environmental conditions between different types of plants, and in particular, between different cultivars within a species.

### SUMMARY OF THE INVENTION

The following embodiments and aspects thereof are described and illustrated in conjunction with systems, tools and methods which are meant to be exemplary and illustrative, not limiting in scope.

Differences in temperature preference between cultivars within a species can be investigated and quantified by performing optimum plant canopy temperature analysis. Quantifying these cultivar-specific optimum plant canopy temperatures can provide the researcher, breeder or grower with useful information for determining the best environment for growth of a given cultivar. In one embodiment of the invention, methods of determining the optimum plant canopy temperatures in plants, as well as determining differences between plants, such as in specific cultivars within a species, are disclosed.

Methods of determining a desirable plant canopy temperature have been disclosed in the art, for example the BIOTIC method described in U.S. Pat. No. 5,539,637. The BIOTIC method of determining optimal plant canopy temperature has been limited by the test's inaccuracy, lack of repeatability and limitations on data interpretation. The BIOTIC method uses qualitative analysis of data to produce results. These results must be interpreted by a human trained and experienced in the art of analyzing fluorescence assays. The apparatus and method of the claimed invention has resolved these limitations.

In the BIOTIC method, the variable fluorescence procedure can be greatly affected by the angle of the measurement device at the time of measurement and the concentration of PSII reaction centers at the testing site.

In one embodiment of the current invention, human induced error is eliminated by mounting the device to a fixed arm, which guarantees that all measurements are fixed at the proper and consistent angle. This technique also ensures all repeated measurements are tested on the same leaf surface thus the concentration of PSII reaction centers always remains constant with each repeated measurement.

In the BIOTIC method, each location's known temperature value was not recorded at the time of testing.

One embodiment of the current invention records the temperature of the sample's location as the sample is tested. In one embodiment, the defined sample locations and attached thermistors at those known locations, increases the precision and repeatability of results.

One embodiment employs a mathematical approach to create a quantified, non-biased answer. In one embodiment, the data collected by the OPCT methodology can be quickly imported into an algorithmic engine to produce quantitative results.

One embodiment is an apparatus for determining the optimal plant canopy temperature of a plant comprising a temperature gradient table, a thermal plate located on the upper surface of the temperature gradient table, a temperature gradient mechanism connected to the thermal plate, a temperature sensor connected to the thermal plate, a mobile mechanism, a fluorometer; a measurement probe operably connected to the fluorometer and the mobile mechanism such that the mobile mechanism can move the measurement probe into multiple positions above the thermal plate and a computer operably linked to the temperature sensor, the fluorometer and the mobile mechanism.

In one embodiment the temperature gradient mechanism comprises a first and second channel on opposite sides of the thermal plate suitable to pass liquids through or along the thermal plate, a cool thermal fluid inlet at one end of the first channel, a cool thermal fluid outlet at the second end of the first channel, a hot thermal fluid inlet at one end of the second channel, a hot thermal fluid outlet at the second end of the second channel, a cold liquid circulator connected to the cool thermal fluid inlet, and a hot liquid circulator connected to the hot thermal fluid inlet.

In one embodiment, the temperature gradient mechanism comprising one or more additional channels

In one embodiment, the temperature gradient mechanism comprises a Peltier device.

In one embodiment, the temperature gradient mechanism comprises a liquid immersion bath wherein the bottom layer of the thermal plate is in contact with the liquid.

In one embodiment, a pedestal for holding a sample is located on the thermal plate and the temperature sensor is connected to the pedestal.

In one embodiment, the computer comprises instructions for recording data from the fluorometer and temperature sensor, and positional information of the measurement probe.

In one embodiment, the mobile mechanism is a robotic arm.

In one embodiment, the computer comprises instructions for moving the mobile mechanism so that the measurement probe is positioned above a position on the thermal plate.

In one embodiment, the instructions move the mobile mechanism at specific time intervals.

In one embodiment there are multiple pedestals.

In one embodiment, the pedestal is located on a removable fixture plate which is attached to the thermal plate.

In one embodiment, multiple pedestals are located on the removable fixture plate.

In one embodiment, the apparatus comprises a light source.

In one embodiment, the apparatus comprises a light intensity sensor.

In one embodiment, the mobile mechanism can move the measurement probe in x, y and z axes.

One embodiment of the invention relates to a method of collecting data comprising obtaining leaf material of a plant, preparing leaf samples from said leaf material, placing the leaf samples on a temperature gradient surface so that the leaf samples will be at various temperatures, exposing the leaf samples to light for a period of time, measuring the intensity of the light source, measuring the fluorescence of the leaf samples with a probe, measuring the temperature of each leaf sample; and recording the position of the probe.

In one embodiment, the method is performed with the apparatus described herein.

In one embodiment, the light exposure is from 1 to 120 minutes.

In one embodiment, multiple individual plants are tested.

In one embodiment, the multiple individual plants to be tested differ in the presence of at least one gene.

In one embodiment, the multiple individual plants to be tested differ in the presence or absence of at least one protein.

In one embodiment, multiple lines, hybrids or varieties of a single plant species are tested.

In one embodiment, plants from multiple species are tested.

In one embodiment, the plant is selected from the group consisting of a non-vascular plant, a vascular plant, a shrub, a seedling, a grass variety, a tree, a bush, and a vine.

In one embodiment, the plant is a monocotyledonous plant or a dicotyledonous plant.

In one embodiment, wherein the plant is a crop plant.

In one embodiment, the crop is selected from a food crop, a biofuel crop, and a commercial crop.

Other aspects, features, and advantages of the present invention will become apparent from the following detailed description. It should be understood, however, that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Exemplary embodiments are illustrated in the drawings. It is intended that the embodiments and figures disclosed herein are to be considered illustrative rather than limiting. For a detailed description of various embodiments, reference will now be made to the accompanying illustrative drawings in which:

FIG. 1 is a diagram of one embodiment of a temperature gradient table for the obtaining of variable fluorescence measurements, as described in Example 1.

FIG. 2 provides a schematic illustration of one embodiment of a computer system (200) that can perform the methods provided by various other embodiments, as described herein. It should be noted that FIG. 2 is meant only to provide a generalized illustration of various components, of which one or more (or none) of each may be utilized as appropriate. FIG. 2, therefore, broadly illustrates how individual system elements may be implemented in a relatively separated or relatively more integrated manner.

FIG. 3A is a graph demonstrating the shape of a plot of Fᵥ/F₀ vs. time for a leaf sample when the leaf temperature is lower than optimal. There is a slow rise in the Fᵥ/F₀, but it does not reach the point of leveling off during the remaining test period.

FIG. 3B is a graph demonstrating the shape of a plot of Fᵥ/F₀ vs. time for a leaf sample when the leaf temperature is optimal. After an initial fast rise in Fᵥ/F₀, the level becomes stable over the remaining testing period.

FIG. 3C is a graph demonstrating the shape of a plot of Fᵥ/F₀ vs. time for a leaf sample when the leaf temperature is higher than optimal. The Fᵥ/F₀ rises quickly, but falls off over time.

FIG. 4 shows two panels of line graphs of Fᵥ/F₀ vs. time for leaf samples taken from the rice plant cultivar growing in plot 1. Two tests were performed. Panel A shows the results of the first test; Panel B shows the results of the second test.

FIG. 5 shows two panels of line graphs of Fᵥ/F₀ vs. time for leaf samples taken from the rice plant cultivar growing in plot 2. Two tests were performed. Panel A shows the results of the first test; Panel B shows the results of the second test.

FIG. 6 shows two panels of line graphs of Fᵥ/F₀ vs. time for leaf samples taken from the rice plant cultivar growing in plot 3. Two tests were performed. Panel A shows the results of the first test; Panel B shows the results of the second test.

FIG. 7 shows two panels of line graphs of Fᵥ/F₀ vs. time for leaf samples taken from the rice plant cultivar growing in plot 4. Two tests were performed. Panel A shows the results of the first test; Panel B shows the results of the second test.

FIG. 8 shows two panels of line graphs of Fᵥ/F₀ vs. time for leaf samples taken from the rice plant cultivar growing in plot 5. Two tests were performed. Panel A shows the results of the first test; Panel B shows the results of the second test.

FIG. 9 shows two panels of line graphs of Fᵥ/F₀ vs. time for leaf samples taken from the rice plant cultivar growing in plot 6. Two tests were performed. Panel A shows the results of the first test; Panel B shows the results of the second test.

FIG. 10 shows two panels of line graphs of Fᵥ/F₀ vs. time for leaf samples taken from the rice plant cultivar growing in plot 7. Two tests were performed. Panel A shows the results of the first test; Panel B shows the results of the second test.

FIG. 11 shows two panels of line graphs of Fᵥ/F₀ vs. time for leaf samples taken from the rice plant cultivar growing in plot 8. Two tests were performed. Panel A shows the results of the first test; Panel B shows the results of the second test.

FIG. 12 shows two panels of line graphs of Fᵥ/F₀ vs. time for leaf samples taken from the rice plant cultivar growing in plot 9. Two tests were performed. Panel A shows the results of the first test; Panel B shows the results of the second test.

FIG. 13 is a panel of line graphs of Fᵥ/F₀ vs. time for leaf samples taken from the rice plant cultivar growing in plot 10. Only one test was performed for this plot.

FIG. 14 is a panel of line graphs of Fᵥ/F₀ vs. time for leaf samples taken from the rice plant cultivar growing in plot 11. Only one test was performed for this plot.

FIG. 15 shows two panels of line graphs of Fᵥ/F₀ vs. time for leaf samples taken from the rice plant cultivar growing in plot 12. Two tests were performed. Panel A shows the results of the first test; Panel B shows the results of the second test.

FIG. 16 shows two panels of line graphs of Fᵥ/F₀ vs. time for leaf samples taken from the rice plant cultivar growing in plot 13. Two tests were performed. Panel A shows the results of the first test; Panel B shows the results of the second test.

FIG. 17 shows two panels of line graphs of Fᵥ/F₀ vs. time for leaf samples taken from the rice plant cultivar growing in plot 14. Two tests were performed. Panel A shows the results of the first test; Panel B shows the results of the second test.

FIG. 18 shows two panels of line graphs of Fᵥ/F₀ vs. time for leaf samples taken from the rice plant cultivar growing in plot 15. Two tests were performed. Panel A shows the results of the first test; Panel B shows the results of the second test.

FIG. 19 shows two panels of line graphs of Fᵥ/F₀ vs. time for leaf samples taken from the rice plant cultivar growing in plot 16. Two tests were performed. Panel A shows the results of the first test; Panel B shows the results of the second test.

FIG. 20 shows two panels of line graphs of Fᵥ/F₀ vs. time for leaf samples taken from the rice plant cultivar growing in plot 17. Two tests were performed. Panel A shows the results of the first test; Panel B shows the results of the second test.

FIG. 21 shows two panels of line graphs of Fᵥ/F₀ vs. time for leaf samples taken from the rice plant cultivar growing in plot 18. Two tests were performed. Panel A shows the results of the first test; Panel B shows the results of the second test.

FIG. 22 shows two panels of line graphs of Fᵥ/F₀ vs. time for leaf samples taken from the rice plant cultivar growing in plot 19. Two tests were performed. Panel A shows the results of the first test; Panel B shows the results of the second test.

FIG. 23 shows two panels of line graphs of Fᵥ/F₀ vs. time for leaf samples taken from the rice plant cultivar growing in plot 20. Two tests were performed. Panel A shows the results of the first test; Panel B shows the results of the second test.

FIG. 24 shows two panels of line graphs of Fᵥ/F₀ vs. time for leaf samples taken from the rice plant cultivar growing in plot 21. Two tests were performed. Panel A shows the results of the first test; Panel B shows the results of the second test.

FIG. 25 shows two panels of line graphs of Fᵥ/F₀ vs. time for leaf samples taken from the rice plant cultivar growing in plot 22. Two tests were performed. Panel A shows the results of the first test; Panel B shows the results of the second test.

FIG. 26 shows two panels of line graphs of Fᵥ/F₀ vs. time for leaf samples taken from the rice plant cultivar growing in plot 23. Two tests were performed. Panel A shows the results of the first test; Panel B shows the results of the second test.

FIG. 27 shows two panels of line graphs of Fᵥ/F₀ vs. time for leaf samples taken from the rice plant cultivar growing in plot 24. Two tests were performed. Panel A shows the results of the first test; Panel B shows the results of the second test.

FIG. 28 is a dot plot graphical representation of the optimum canopy temperatures for each of the 24 tested rice varieties.

FIG. 29 is an example of the hot and cold curstolics. (Show shoulders chart with diamonds.)

FIG. 30 is an example of a complete set up of one embodiment of the apparatus.

FIG. 31 is an example of a cooling water circulator used to generate a temperature gradient on the table of the apparatus.

FIG. 32 is view of the data loggers located on the back of machine table in one embodiment of the apparatus.

FIG. 33 is a view of the gradient table with fixture plates attached and thermistors attached.

FIG. 34 is a view of the fluorometer head (measurement probe) attached to a mobile mechanism (CNC).

FIG. 35 is an example of a heating water circulator used to generate a temperature gradient on the table of the apparatus.

FIG. 36 is a schematic overview of an agricultural management system in accordance with one embodiment of the invention.

FIG. 37 is a flowchart of an agricultural management method and system of one embodiment of the invention.

FIG. 38 is a front view of the inside of the field base station in accordance with one embodiment of the invention.

### DESCRIPTION OF THE TABLES

Table 1 is a description of the various fluorescence parameters used for the determination of optimal plant canopy temperature.

Table 2 shows examples of stress range settings for different plant types.

Table 3 is a summary table of the optimum canopy temperature determination for each of the 24 rice test plots.

Table 4 provides specific examples of components and suppliers used in one embodiment of the invention.

### DETAILED DESCRIPTION OF THE INVENTION

Optimal Plant Canopy Temperature refers to the metabolic state in which the various facets of metabolism are coordinated in such a manner that the performance of the plant is not limited by temperature. In some embodiments, the apparatus and methods disclosed herein can quickly and effectively determine the optimum canopy temperature of a plant, whether it be a specific cultivar, a plant derived from a breeding program, a commonly grown commercial crop plant, a transgenic plant, a plant having an induced or natural mutation, or another type of plant. In order to determine the optimal plant canopy temperature, the general method involves taking leaf samples from the plant to be tested, arranging the leaf samples along the length of a temperature gradient table so that the leaf samples will be at a range of different temperatures, exposing the leaves with light for a time, and then using a fluorometer to measure chlorophyll a fluorescence. By determining the ratio of variable fluorescence over minimal fluorescence over a period of time for leaf samples being held at different temperatures, and further by graphing the measurements and comparing the graphical outcomes of leaf samples being held at different temperatures or otherwise processing the data mathematically, one can determine the optimal plant canopy temperature for a given plant or cultivar.

There is a need to understand if any differences exist among cultivars within a specific species such that these differences result in different optimum plant canopy temperatures. These differences could be used to optimize plant-breeding efforts and to optimize planting locations by matching a cultivar's optimum plant canopy temperature to the growing climate. The apparatus and methods disclosed herein are useful tools for determining a plant's level of stress and its water availability. The temperature of the plant, compared to its biological optimum temperature, indicates the level of water-related stress and heat-related stress the plant is experiencing. The comparison of the plants temperature to its biological optimum and/or the hot and/or cold curstolic can also indicate the impact of topical applications, pathogens, and pests. In one embodiment, these comparisons can be evaluated with a seasonal summary or at specific growth stages. These comparisons can provide valuable information in the selection of variety, lines and hybrids, provide signals for fertility and growth stage changes.

In one embodiment, using the tools and methods of the invention can assist in validating the selection of variety, lines and hybrids much earlier than using traditional methods.

The inventors made additional discoveries as a result of increased testing at different periods of the planting season. One discovery was that as the plant matures or moves from one growth stage to another it's optimal plant canopy temperature may change. Another discovery was that different types of plants, and in particular, between different cultivars within a species had different optimal thermal boundaries, defined as hot and cold curstolics

Certain terms are used throughout the following description to refer to particular apparatus and method components. As one skilled in the art will appreciate, design and manufacturing companies may refer to a component by different names. In the following discussion, the terms “including” and “comprising” are used in an open-ended fashion, and thus should be interpreted to mean “including, but not limited to . . . .”

### DEFINITIONS

Agronomic trait. A phenotypic trait of a plant that contributes to the performance or economic value of the plant. Such traits include disease resistance, insect resistance, virus resistance, nematode resistance, drought tolerance, high salinity tolerance, yield, plant height, days to maturity, and the like.

Allele. Any of one or more alternative forms of a gene locus, all of which alleles relate to one trait or characteristic. In a diploid plant, the two alleles of a given gene occupy corresponding loci on a pair of homologous chromosomes.

Canopy. The canopy is the totality of the leaves of a plant. The canopy can also be at least one leaf of the plant. The canopy captures light energy through the process of photosynthesis, providing energy for plant growth.

Channel. A passageway along or within a thermal plate that allows the flow of a liquid along or through the plate.

Chlorophyll fluorescence. Chlorophyll fluorescence is light that has been re-emitted after being absorbed by chlorophyll molecules of plant leaves.

Cold Curstolic. The low temperature outside limit as defined or characterized during the determining of the Optimal Plant Canopy Temperature using observed reduction to Photosystem II performance.

Cold Thermal Fluid Inlet/Outlet. An end of a channel along or within a thermal plate to allow the flow of a cooled liquid along or within a thermal plate to establish a temperature gradient on the plate.

Cultivar. A variant member of a species. Members of a particular cultivar are not necessarily genetically identical. In general, a cultivar is an assemblage of plants that has been selected for a particular characteristic or combination of characteristics, is distinct, uniform and stable in those characteristics, and retains those characteristics when propagated. The terms cultivar and variety are often used interchangeably.

Data Logger. An electronic device for recording information obtained from sensors. In some embodiments, data loggers collect the data obtained from temperature sensors. A data logger may be operably connected to a computer and capable of transmitting data to the computer.

Exposure of the leaf sample to light. Prior to fluorescence measurement, the leaf samples are exposed to a photosynthetic light up to 350 μmol/m̂2/s for a period of time. The light intensity and duration can be adjustable so long as the initial Fv/Fo measurement is low, below 0.4.

Fixture Plate. A removable plate resting on the thermal gradient plate. These plates are placed at defined temperature zones and can house, in some embodiments, multiple pedestals up to 10 pedestals.

Fluorometer. A fluorometer is an apparatus that measures fluorescence. In plant leaves, a fluorometer measures the fluorescence (intensity and wavelength) that is emitted from a plant leaf after the leaf has been excited by a light spectrum.

Fₘ. This is the maximum level of fluorescence yield. Fₘ is typically measured after a saturating flash of non-photosynthetic light, which acts to close the PSII reaction centers so that they are unavailable for excitation.

Fₒ. Minimal fluorescence from a light-adapted leaf. This is the amount of fluorescence that occurs when the electron receptors of Photosystem II (PSII) are maximally open, i.e. are available to be excited. In one embodiment, the Fₒ value measured herein is determined after exposing the leaves to a weak red spectrum light for a period of one second, which forces the evacuation of Photosystem II into Photosystem I.

Fₛ. This is another term for the ratio of Fᵥ to Fₒ.

F. Variable fluorescence from a light adapted leaf. This value demonstrates the ability of PSII to perform primary photochemistry. This value is generally calculated, rather than measured. The calculation is Fₘ−Fₒ.

Fᵥ/Fₒ. This is the ratio of Fᵥ to Fₒ. It is calculated as Fᵥ divided by the minimal fluorescence determination, Fₒ.

Genetic differences. Differences in at least one location on the DNA of the plant. This can lead to differences in an altered gene, an altered gene expression pattern, altered protein expression, altered phenotype, and/or an altered environmental stability.

Heat Units. Heat units are a measure of time corrected for the environmental effect of temperature. Heat units typically begin to accumulate at planting and continue to accumulate daily until plant harvest.

Hot Curstolic. The high temperature outside limit as defined or characterized during the determining of the Optimal Plant Canopy Temperature using observed reduction to Photosystem II performance.

Hot Thermal Fluid Inlet/Outlet. An end of a channel along or within a thermal plate to allow the flow of a heated liquid along or within a thermal plate to establish a temperature gradient on the plate.

Initial rise in Fᵥ/Fₒ. This initial rise can generally occur in a range of from about 3 or 4, to about 5, 6, or 7 minutes, including integers and fractions thereof. In some embodiments, the shape of the initial rise can predict the level of temperature-related stress that the leaf has experienced.

Leaf material. Leaves from the plant to be tested. Whole leaves, leaf portions, branches with leaves, or whole plants can be obtained from the field or greenhouse to prepare for the leaf sample preparation.

Leaf sample. Any size portion of a leaf, or an entire leaf. A leaf sample can be separated from remainder of the leaf by any means, such as cutting, tearing, punching, and the like. The leaf sample can be cut, torn, punched, etc. from the remainder of the leaf. The leaf sample can be circular, square, or any other shape, such as a freeform shape.

Management Decision. A decision regarding the management of the crop. This can be a short term decision, such as turning the irrigation on or off, or it can be a long term decision, such as allowing a crop to undergo a certain amount of plant stress in order to save water. The management decision is not limited to determining the timing and application of irrigation, however. The management decision can be related to predicting future yield, the timing and application of pesticides, growth regulators, growth hormones, herbicides or fungicides. The management decision can also be related to alerting additional entities, such as investors, insurance companies, agricultural management experts, and the like.

Measurement probe. A machined part that holds the measuring device(s) at a defined angle and position. In some embodiments, this part is attached to a mechanized arm to provide for automated movement.

Microprocessor. A microprocessor incorporates the functions of a computer's central processing unit (CPU) on an integrated circuit or microchip. It is a multipurpose, programmable, electronic device that processes input binary data and provides the results as output.

Mobile mechanism. A mechanism, such as a robotic arm, which allows for the movement of another component, such as a probe, relative to other elements of the apparatus. In many embodiments, the mobile mechanism contains motors that allow its movement to be self-propelled.

Mutation. An altered genetic structure of the DNA of an organism. In plants, a mutation can be a point mutation, a deletion of a gene or portion thereof, or other changes to the DNA of the plant. An altered phenotype, such as growth changes, morphological changes, or an altered response to environmental conditions, can occur in the plant having the mutation.

Optimal plant canopy temperature range for growth of a crop. Similar to the OPCT range, this is the temperature range at which a crop will have the highest rate of photosynthesis and vegetative and reproductive growth. Determining the OPCT for a leaf or a sample plant of a cultivar can predict the OPCT for the growth of an entire crop of that cultivar.

Optimum growth. This term generally refers to the optimal vegetative growth of a plant. The term can also refer to optimum yield of a commercial product derived from the plant (such as, for example, fruit, seeds, etc.). This can be measured, for example, by yield of plant material, yield of a specific product of the plant, plant height, plant growth per day, total leaf area, total plant weight, or by other suitable means.

Optimum Plant Canopy Temperature (OPCT). Optimal plant canopy temperature refers to the metabolic state in which the various facets of metabolism are coordinated in such a manner that the performance and yield of the plant is not limited by temperature. In general, the OPCT is the temperature at which vegetative plant growth occurs the fastest. At this temperature, the plant can perform photosynthesis quickly, and can accumulate assimilate at a high rate. The end result of this increased photosynthesis and assimilate accumulation is a higher rate of vegetative growth of the plant and a higher final yield of the product, grain or lint yields.

Optimum leaf canopy temperature range. The range of OPCT is the temperature range at which the vegetative plant growth occurs the fastest. For some plants, this range may be narrow, and for other plants, the range may be wider. The hot and cold curstolics define these ranges.

Pedestal. Raised segment on fixture plates which will hold one sample. As used herein, “multiple pedestals” refers to two or more pedestals.

Peltier device. A device that creates a change in temperature through the application of an electric current.

Plant material. As used herein, the term “plant material” (or a crop, a plant, or a part thereof) includes but is not limited to protoplasts, whole plants, leaves, leaf segments, leaf samples, leaf tissues, stems, roots, root tips, anthers, pistils, seed, grain, embryo, pollen, ovules, cotyledon, hypocotyl, pod, flower, shoot, petiole, tissues, cells, meristematic cells and the like.

Plant stress. Environmental conditions that somewhat decrease or inhibit the ability of the plant to grow and develop efficiently to its full capacity. The stress can be an abiotic stress or a biotic stress. Examples of abiotic stress include heat stress, cold stress, freezing stress, or water-related stresses such as water deficit stress, drought stress, or stress from too much water in the soil. A plant stress condition can occur occasionally, sporadically, commonly, or constantly.

Plant variety. A plant variety is a plant grouping within a single botanical species. Although two different varieties within a species would both be grouped as being members of one specific species, each of them contains at least one genetic difference or phenotypic difference from any other variety of the same species.

Riemann Sum. This describes a method for approximating the total area underneath a curve on a graph. This term is also known as an “integral”. This method can be used, for example, to determine the area under the curve for the “accumulated stress count” or the “Smartfield Stress Index” or other plant stress analysis models described herein.

RH pod. A device for determining the relative humidity of its environment. The RH pod may be operably connected to a computer and capable of transmitting data to the computer. The RH pod may also record and transmit temperature data.

Smartfield Stress Index or Stress Index (SSI). This is a ratio, which compares plant canopy temperature and ambient temperature of a given field, using a “Riemann sum” method. The SSI uses the optimum plant canopy temperature, or optimal growing temperature, of the plant as a baseline for the temperature measurements. SSI provides information regarding plant stress that is independent of factors such as relative humidity. The general calculation is:

(((the area under the observed canopy temperature and above the optimal canopy temperature) divided by (the area under ambient temperature and above optimal temperature)) minus 1)×100

Stress range grouping. Non-Stressed (normal growth), Normal Stress, High Stress, or Extreme Stress. As used herein, these terms are used to indicate the relative degree of harm a plant canopy is exposed to by having an elevated temperature above its optimum canopy temperature or optimal growing temperature. This amount can differ with different crop types or different plant varieties. A non-stressed plant is at or near the optimal canopy temperature, and is thus undergoing no temperature stress. Normal stress is a slight temperature elevation above the optimal. High stress is a higher temperature above the optimal. Extreme stress is a canopy temperature that is much higher than “high stress”—at this temperature the plant can die, or the yield of the crop may be severely damaged. The range of temperatures for each of these stages can be determined by the user, depending on the specific crop and other parameters.

Temperature gradient mechanism. A mechanism that can establish a temperature gradient long a surface. Such mechanisms can include a Peltier device which heats and cools based on electric current, a mechanism based on the flow of heated and cooled liquids along or through a surface, or a liquid immersion bath mechanism, such as a water bath, wherein the bottom layer of a surface plate in placed in contact with heated or cooled liquids.

Temperature gradient plate (or table or surface). The temperature gradient plate is a table or other flat surface that can be set to have a lower temperature at one side, and a higher temperature at the other side. Once the table reaches equilibrium, a temperature gradient is created from one side of the table to the other.

Thermal plate. The upper surface of a temperature gradient table on which the temperature gradient may be established.

Timed Intervals. A definite length of time marked off by two instants. As used herein, the various crop sensors are set to take readings at specific timed intervals. The timed intervals can be changed as needed. Timed intervals can be set, for example, at every 0.25 second, every 0.5 second, every second, every thirty seconds, every minute, every 5 minutes, every 15 minutes, every 30 minutes, every hour, or more, as desired. There can also be timed intervals, for example, for transmitting the data from a sensor to a crop field station, transmitting the data from the field station to the central processing unit, performing data analysis, sending the information to the user, and sending the information to an irrigation control device. Different crop sensors and different data input information can have different timed intervals, if desired.

As an example of using various timed intervals for different aspects of the crop monitoring and analysis process, in an embodiment, the leaf temperature sensor can take readings at timed intervals of every 1 minute, while the ambient temperature sensor takes readings at timed intervals of every 5 minutes. The data is transmitted to the field station at timed intervals of every minute. The readings for several different leaf temperature sensors throughout the field are collected by the field station, for example, every 5 minutes, and then transmitted to the central processor, for example, every 5 minutes. The central processor can analyze the data, for example, every 15 minutes, and can update the results on a website display at a timed interval of every 30 minutes.

Topical Application. Any application to a crop or field, including but not limited to herbicide, pesticide, growth hormone, growth regulator, and fungicide.

Transgene. A nucleic acid segment that is present in a plant genome, which is normally not present in that plant genome. The nucleic acid segment can be, for example, a gene, a fragment of a gene, an antisense sequence, an RNAi-type sequence, and the like. The nucleic acid sequence can be synthetically derived, or can be derived from another type of organism, another species, or another plant.

Trigger. A pre-determined numerical value at which a decision is made to provide an alert to the user (such as a grower or a management entity) regarding a crop management decision, or to automatically initiate a crop management decision, such as the initiation of irrigation. The trigger value can indicate a degree of plant stress that the plant is experiencing due to water deficit and high leaf temperature. The trigger value can be based on various types of calculations, such as those described herein. The trigger can be based, for example, on a calculation of the accumulated time above optimum and the number of degrees above an optimal temperature for a given day, week, or even for the entire crop growing season. The trigger can be based on the accumulated area under the curve between the optimal temperature and the canopy temperature. The trigger can also be based on a value determined from the “Smartfield Stress Index”, or “stress index”. The trigger can also be based on the calculations using the curstolics, for example a rising or lowering of temperature above or below the temperatures of the hot and cold curstolics, or the amount of time spent outside of the range defined by the curstolics. The trigger value can also be based on analysis that involve predictions, such as, for example, predictions of future weather patterns, future water availability, future water costs, future energy costs, future crop prices, and the like.

User for crop management. In general, the user is the pre-determined person or entity that is to be notified upon a trigger alert. The user can be the grower, a field worker, an agricultural management company, an agricultural insurance company, an investor, or any other person who is pre-determined to be notified of an alert. The user can also be a non-human entity, such as an irrigation control device, a remote irrigation control device, a communications device, and the like.

Water stressed. A decreased ability of the plant to perform physiological functions at its normal rate, due to an inadequate supply of water to the plant. The stress period can vary widely. For example, the period of water stress can be a few minutes, to hours, to days, or can be intermittent, or constant. The plant may or may not be able to adjust to the water stress.

Web Server. The general term “Web server” can refer to either the computer (hardware) or the computer application (software) involved in the content delivery. Web servers can host web sites, and can also be involved in data storage, running enterprise applications, or other uses.

Yield. The yield is typically the total weight of an agronomic product or the biomass of a plant at harvest. This can be measured, for example, on a per area basis, or on a per plant basis. In some embodiments, the yield can also be measured as the weight per plant, or the weight of vegetative material or biomass of a plant, either at the end of the growing period, or at specific time points during growth.

TABLE 1
Photosynthetic Measurement Definitions and Parameters

| Parameter | Definition | Physiological Significance |
|---|---|---|
| F and F′ | Fluorescent emission from a | Little value physiologically because emission is |
| | dark adapted (F) or a light | affected by a large number of factors |
| | adapted (F′) leaf | |
| Fₒ and Fₒ′ | Minimal fluorescence from | The amount of fluorescence that occurs when the |
| | dark- or light-adapted leaf | electron receptors of Photosystem II (PSII) are |
| | | maximally open, i.e. are available to be excited. |
| Fₘ and Fₘ′ | Maximum fluorescence | The level of fluorescence detected when the PSII |
| | from a dark- or light- | centers are closed, i.e. unavailable for excitation. |
| | adapted leaf | Fₘ and Fₘ′ are measured after a saturating flash |
| | | of non-actinic light (it is non-actinic because of |
| | | the short duration of the flash). |
| Fᵥ and Fᵥ′ | Variable fluorescence from | This value demonstrates the ability of PSII to |
| | a dark- or light adapted leaf | perform primary photochemistry. It is calculated |
| | | (rather than measured) and is Fₘ-Fₒ (or Fₘ′- |
| | | Fₒ′) |
| Fᵥ/Fₘ | Maximum quantum | Maximum efficiency at which light absorbed by |
| | efficiency of PSII | PSII is converted to chemical energy |
| | photochemistry | |
| Fᵥ′/Fₘ′ | PSII Maximum Efficiency | Estimates maximum efficiency of photochemistry |
| | | in PSII at a given light intensity |

Different types of plants are adapted to grow under varying environmental conditions, such as temperature, water availability, soil nutrient content, humidity, biotic stress, etc. Some plants are able to photosynthesize and grow well at extremes of high or low temperatures, while other plants cannot. Some plants may be able to grow well under a wide temperature range, while other plants need a very narrow temperature range to thrive. One way to test for the optimal temperature environment for a given plant is to study its photosynthesis-related leaf fluorescence characteristics.

Photosynthesis is the process by which plants transform light energy into chemical energy. The process involves a number of photochemical and enzymatic reactions. Light energy is captured by chlorophyll in the chloroplasts of the leaves and used to convert water, carbon dioxide, and minerals into oxygen and energy-rich organic compounds that will be used for the growth of the plant.

In addition to its use for the production of carbon compounds, light energy that is absorbed by the chlorophyll molecules in the leaf can also be either dissipated as heat, or it can exit the leaf by means of fluorescence. Chlorophyll fluorescence is light that has been re-emitted after being absorbed by chlorophyll molecules of plant leaves. This can be measured using a fluorometer. Changes in the physiology of the leaf can be detected by changes in chlorophyll fluorescence. In embodiments of the invention, fluorescence emission from plant leaves is used to calculate the OPCT for plant growth.

In some embodiments, the OPCT of an entire crop or a single plant can be determined by analyzing the variable fluorescence emission from its leaves. In one embodiment, a leaf sample is taken from a non-stressed, well irrigated crop from the field and tested as quickly as possible.

In another embodiment, plant material is taken from stressed plants and evaluated in like manner of a well irrigated plant sample. In one embodiment, multiple samples are prepared and placed on a temperature gradient plate so that leaf samples are tested over a temperature range, as described in Examples 1 and 2. The leaf material is then “charged” with photons for a period of time (see Example 3). The lighting is then turned off, and a chlorophyll variable fluorescence test is performed to determine leaf fluorescence over time. The fluorometer measures the amount of additional light energy that can be absorbed by the leaf compared to the amount of light energy that is reflected by the leaf. This energy usage test is performed over a period of time with multiple readings repeated at specific intervals so that the energy absorbed by the plant can be tested over this period of time. The more energy the leaf absorbs, the more energy the leaf is using. Since the measurement is performed as specific temperatures along a temperature gradient, the information gleaned from the fluorescence measurement leads to the determination of the efficiency of the leaf material at that temperature. By performing this measurement over multiple temperatures with the same leaf material (Example 4), determination of the leaf's performance versus temperature is revealed (Example 5).

This individual calculation of the optimum temperature of a leaf sample correlates well with the optimum plant canopy temperature of the entire plant, as well as the optimum canopy temperature of an entire field that has been planted with a specific cultivar. Knowing the preferred canopy temperature for optimum growth of a specific cultivar can save the grower watering costs and management costs, and can also inform a grower whether or not certain plants are suitable for growing in certain environments. This can also be used to select variety, lines and hybrids and/or used to select transgenic constructs for performance for plant breeders, researchers, genotype and trait developers, and growers. Users can also use OPCT and/or the Curstolics for determining product placement.

Types of Plants that can be Used in the Present Invention

In some embodiments, the apparatus and method can be used to test for the optimum plant canopy temperature of any type of plant. The plant can be, for example, a non-vascular plant, a vascular plant, an angiosperm, a gymnosperm, a monocot, or a dicot. In some embodiments, the plant is a crop plant. Exemplary plant types that can be measured by this method include but are not limited to: an annual, a perennial, an herb, a shrub, a seedling, a food crop, a biofuel crop, a commercial crop, a grass variety, a tree, a bush, a vine, and the like.

Exemplary plant species that can be measured include, but are not limited to canola (Brassica napus, Brassica rapa ssp.), corn (Zea mays), Sorghum (Sorghum bicolor, Sorghum vulgare), alfalfa (Medicago sativa), rye (Secale cereale), sunflower (Helianthus annuus), wheat (Triticum aestivum), soybean (Glycine max), tobacco (Nicotiana tabacum), potato (Solanum tuberosum), millet (Panicum spp.), peanut (Arachis hypogaea), melon (Cucumis melo), cotton (Gossypium hirsutum), blackberry (Rubus spp.), sweet potato (Ipomoea batatus), cassaya (Manihot esculenta), papaya (Carica spp.), coffee (Cofea spp.), watermelon (Citrullus lanatus), coconut (Cocos nucifera), pineapple (Ananas comosus), citrus tree (Citrus spp.), cocoa (Theobroma cacao), tea (Camellia sinensis), almond tree (Prunus amygdalus), apple tree (Malus domestica), plum tree (Prunus spp.), cherry tree (Prunus avium), peach tree (Prunus persica), pear tree (Pyrus communis), banana (Musa spp.), avocado (Persea americana), fig (Ficus casica), rice (Oryza sativa), guava (Psidium guajava), mango (Mangifera indica), pepper (Capsicum spp.), olive (Olea europaea), oat (Avena sativa), grape (Vitis spp.), barley (Hordeum vulgare), and flower types such as rose (Rosa spp.), chrysanthemum (Chrysanthemum spp.), carnation (Dianthus spp.), lavender (Lavandula spp.), tulip (Tu/ipa spp.), and the like.

In one embodiment, the plant to be tested can be growing in any suitable growing environment. In one embodiment, the plant can be growing indoors or can be growing outdoors. In one embodiment, the plant can be in a pot or in the ground. In one embodiment, the plant can be growing, for example, in a petri dish or similar sample dish, in plug tray, propagation tray, flat, in a hydroponic system, in a greenhouse, or in a growth chamber. In one embodiment, the plant to be tested can be growing outdoors, either in a container or in the ground. In one embodiment, the plant can be from a test plot or from an established crop. In one embodiment, the plant is well irrigated and has not been under significant stress. However, the test can also be performed on plants that are or have been stressed. Exemplary plant stresses include but are not limited to abiotic stress, biotic stress, temperature stress, nutrient stress, or other stressors. In some embodiments, the plant can be a variety, cultivar, or the like that is intended for use in home gardens, commercial outdoor production, or greenhouse production.

Additionally, in some embodiments, the method of the invention can be used to determine whether the introduction of a transgenic sequence or a mutation has an effect on the optimal plant canopy temperature of the plant. The plant to be tested can contain a transgenic sequence or a mutation. In another embodiment, the method of the invention can be used to screen plant progeny from an induced mutagenesis procedure for variations in optimal plant canopy temperature.

In some embodiments, the plant to be tested is the result of a test cross or a breeding program. The method can be used to screen the progeny from a breeding cross for plants with a higher or lower optimal plant canopy temperature. The method can also be used as part of a general plant characterization process to determine physiological differences in progeny of a breeding cross.

In some embodiments, the apparatus and methods of the invention can be used to predict which cultivars will have a better chance at survival in low water or high temperature regions. For example, plants that have a higher optimal plant canopy temperature may be better suited to survive in an environment with higher air temperature, or in environments that are more likely to experience water stress. In certain areas where fields cannot be watered, this canopy temperature optimum can be crucial information for the grower to have prior to planting the field.

In some embodiments, the apparatus and methods of the invention can be used to compare two specific cultivars to determine or quantify differences in their optimal plant canopy temperature.

In some embodiments, the apparatus and method can be used to determine the optimal plant canopy temperature setting for plants that are growing in an indoor greenhouse or other setting where the environment can be controlled.

In some embodiments, the apparatus and method can be used to determine which plant varieties are most suited for growth in areas where the temperature is high, or in areas where frequent droughts occur. The apparatus and method are particularly suitable for finding plant varieties within a species that are suitable for growth in areas where artificial watering cannot be used, such as dry farming lands, or areas where water is unavailable, extremely expensive and/or cost prohibitive.

In some embodiments, the apparatus and method can be used to determine a range of temperatures at which a given plant variety will thrive.

In some embodiments, the apparatus and method can be used to assist in crop management. If the grower knows the optimal plant canopy temperature for a specific crop, he can determine how much water is needed to keep the plant near the optimal plant canopy temperature. This can prevent the costly use of excess water to cool the plant when growing certain varieties that will thrive well on higher temperatures. Additionally, when multiple plant varieties are growing in an area, the grower can adjust the watering level to cool the plants based on each plant type's optimal plant canopy temperature, rather than applying the same amount of water to all of the plants.

In one embodiment, the calculated optimal plant canopy temperature of the plant can be used as part of a crop irrigation management plan. The crop can be tested periodically to determine whether the canopy temperature is above its optimal plant canopy temperature. If so, the irrigation can be initiated for a period of time, after which the temperature can be measured once again, if desired.

Alternatively, in one embodiment, irrigation can be initiated only if the leaf temperature is above a certain amount over the determined optimal plant canopy temperature. This may be useful, for example, when water is expensive, or during certain drought or water availability limitation periods.

During extreme water availability emergencies, a knowledge of the optimal plant canopy temperature can help the grower decide to limit watering to only the amount that is needed to allow the crop to survive the drought period. For example, in one embodiment, the grower can arrange to initiate irrigation only if the leaf temperature is about 1.5° C., 1.7° C., 1.9° C., 2.0° C., 2.3° C., or 2.6° C. (including all integers and fractions thereof) above the determined optimal plant canopy temperature and/or the Hot Curstolic. In one embodiment, the Cold Curstolic can be utilized to withhold irrigation treatment. This method can be used, for example, as part of a drought management plan in regions and/or situations where water for crops competes with water needed for human necessities and/or where water is limited or usage amounts regulated.

### Obtaining the Plant Leaf Material

In some embodiments, fresh plant material can be taken from a non-stressed, well irrigated crop from the field to be tested as quickly as possible. Leaf material from the plants to be examined can be taken from the growing environment, then packaged carefully and transported to the testing location. In one embodiment, the plant material is transported as whole plants that have been recently removed from the soil, with some soil still remaining on the roots. The plant material can also be transported in pots. The testing location can be near the growing location, such as a research laboratory on the grounds of a growing area, or the testing location can be a distance from the growing area.

### Packaging the Plant Material for Transport

In one embodiment, the plant material to be tested is transported with care so as to arrive at the testing location in a healthy, relatively non-stressed condition. In some embodiments, the plant material is taken from the field on one day, packaged immediately, and then transported to the testing location using an overnight courier. Whatever packaging and transport means is used, one can arrange the transport process so that the plants are not substantially stressed prior to the initiation of the OPCT testing.

Sectioning the Leaf Material into Leaf Samples in Preparation for Testing

In one embodiment, leaf samples can be prepared by any suitable means, such as, for example, by using a razor blade, an X-Acto knife, a cork borer, a circular cutting or boring device, by mechanically or hand-tearing the leaf sample from the remainder of the leaf, or by any other suitable means. The leaf samples for the experiments described below were prepared using a razor blade to cut the leaves into ½ inch squares, as described in Example 2. The OPCT measurement can be performed with a leaf sample that is, for example, a whole leaf, plug of leaf, portion of leaf, circular plug, square plug, a leaf punch, or other leaf portion. In some embodiments, whole, uncut leaves can also be used, although this may be particularly useful for plants with smaller leaves, or for plants with leaves that do not fare well after cutting.

The use of multiple duplicate samples of a plant variety at each temperature point on the temperature gradient table allows a more accurate determination of the OPCT. The number of leaf samples from a specific plant cultivar to be placed at a specific test temperature on the gradient plate can be, for example, from 1, 2, 3, 4, 5, 6, 8, 10 or more. The leaf samples can be obtained from multiple plants of the same cultivar, from multiple leaves of one plant, or from multiple portions of one plant leaf. In some embodiments, the measurement of several samples at each temperature point, followed by the calculation of the mean and standard deviation, creates a single data point at each temperature.

In one embodiment, the same leaf sample may be measured at multiple temperatures by moving it to different locations on the temperature gradient table. This has the advantage of having the same concentration of photo receptors in multiple measurements.

### Preparation of the Temperature Gradient Plate

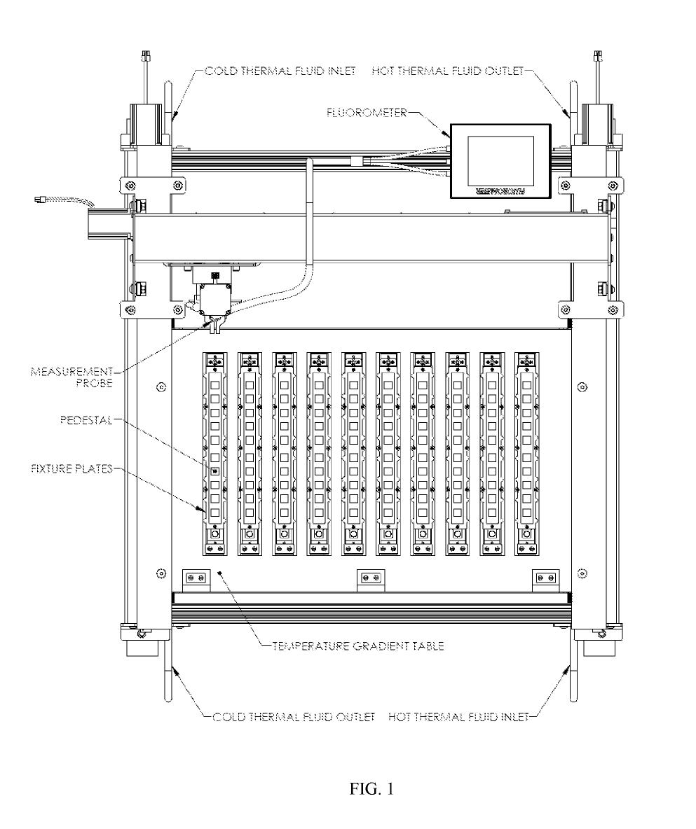

FIG. 1 depicts an embodiment of the apparatus. In this embodiment, a temperature gradient table is shown with ten fixture plates located on the upper surface. Each fixture plate has ten pedestals on it for the placement of samples. The gradient table depicted uses a fluid based mechanism for generating the gradient. On the left side of the table, a cold thermal fluid inlet takes in cold liquid and sends it through a channel in the thermal plate, after which it exits from the cold thermal fluid outlet. Similarly, on the right side of the figure, a hot thermal fluid inlet takes in heated liquid that then moves through a second channel in the thermal plate. Located above the table is a mobile mechanism, in this case a CNC (Computer Numerical Control) arm, which holds a measurement probe. The arm can position the probe at any location above the pedestals to take readings. The probe in connected by a fiber optic cable to a fluorometer which determines and records the fluorescence response of the samples.

In one embodiment, once the leaf samples are prepared, they are placed on a temperature gradient table so that the samples can be tested over a suitable temperature range (see FIG. 1 and Examples 1-2). In one embodiment, the temperature gradient table has a path for water or other cooling/heating agent at each end. By varying the temperature between the two liquid paths at each end of the temperature gradient table, a stable temperature gradient can be created across the surface of the table.

In one embodiment, the temperature gradient plate is a table or other flat surface that can be set to have a lower temperature at one side, and a higher temperature at the other side. Once the table reaches an equilibrium, a temperature gradient is created from one side of the table to the other. In one embodiment, a water bath with a set temperature is set up at each side of the table, and channels through the table allow circulating water to adjust the temperature at each end of the table to the desired temperature and gradient.

The temperature gradient plate can be of any suitable dimensions, and can be made of any suitable material. In one embodiment, the plate is made of a conductive material which readily equilibrates to changes in temperature. In one embodiment, the gradient table is made from an aluminum base, with two channels drilled from front to back at opposite sides to allow the temperature-adjusted water to flow through. In one embodiment, electronically adjusted temperature gradient plates can also be used.

In one embodiment, a temperature gradient plate can also be purchased commercially. Examples include the Grant Temperature Gradient Plate (Grant Instruments (Cambridgeshire, UK), and the Wagtech gradient plate (Wagtech WTD, Palintest LTD, Kingsway, Tyne and Wear, UK).

The temperature gradient plate can be set to test a range of temperatures as desired. For example, the gradient plate can be set so that there is a 1° C., 2° C., 3° C., 4° C. 5° C., 6° C., 8° C., 10° C. or more (including all integers and fractions thereof) range in temperature from one end of the plate to the other end. In some embodiments, the gradient plate can be set to a temperature range of about 15° C., 16° C., 17° C., 18° C., 19° C., 20° C., 21° C., 22° C., 23° C., 24° C., 25° C. or 26° C., 27° C., 28° C., 29° C., 30° C., 31° C., 32° C., 33° C., 34° C., 35° C., to about 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C. or greater, including all integers and fractions thereof, or more.

In one embodiment, the gradient plate is allowed to equilibrate for a time to allow the temperature gradient to stabilize. In one embodiment, an infrared sensor is used to determine the exact location of specific temperatures on the gradient plate. In one embodiment, infrared sensors, thermocouples, thermistors, or RTDs are used to monitor the various temperatures across the gradient plate while the fluorescence testing is being performed.

In one embodiment, the leaf samples are placed across the temperature gradient table. The leaf samples can be placed directly onto the temperature gradient table, or the table can be fitted with an absorbent material that is treated with water or other liquid, so that transfer of temperature to the leaves efficiently occurs. Such absorbent or semi-absorbent material can include, for example, paper, cloth, synthetic material, organic material, or any other suitable material. The leaf samples can also be placed in a sample plate, such as a petri dish, which is then itself placed on the table. If this method is used, an amount of water or other liquid can be added to the bottom of the dish, or the bottom of the dish can be fitted with an absorbent or semi-absorbent material that is then treated with a liquid such as water, to allow a more efficient the transfer of temperature from the gradient plate to the leaf.

In embodiment, defined locations for the samples are not necessary so long as the measurements are taken over a broad area and can then be narrowed down to the actual sample location. A method that could accomplish this is the use of a combination of thermography (FLIR is one manufacturer) and fluorometry cameras (Photo Systems Instruments is one manufacturer). Each of these cameras provide measurements over a large area and come with software that can determine the measurements at user specified pinpoint locations. In some embodiments, either of these options could be used to replace other option described herein options for temperature and fluorometry measurements.

In another embodiment, grid lines or scoring marks may be placed on the table to defined locations for the placement of samples.

In some embodiments, the liquid temperatures at each end of the temperature gradient table are adjusted as needed to create a temperature gradient that is expected to encompass the OPCT for the specific cultivar. In one embodiment, this is done by setting the temperature gradient table so that its lower range will be at a temperature that will be well below the Cold Curstolic, about 2° C. to 10° C. in some embodiments, and to well above the Hot Curstolic, about 30° C. to 40° C. in some embodiments, including all integers and fractions thereof. This way, the optimum plant temperature will fall within the central range of temperatures, rather than being below or above the range tested. Once an initial test is performed to obtain a temperature range estimate, the temperature range can be narrowed to more accurately measure the optimum temperature.

In some embodiments, by varying the size and design of the temperature gradient table, more than forty-five samples can be tested at one time. For example, in one embodiment, one experimental run of temperature gradient table held 90 leaf samples which were prepared from 45 plant samples of two different cultivars of the same species.

Exposing or “Charging” of the Leaf Material with Photosynthetic Light

In one embodiment, the system uses a light source of 6 GE Ecolux high output 54 Watt lightbulbs, model F54W-T5-850-ECO. The light from these bulbs is considered full spectrum light. Distance from the bulbs to the leaf samples depends on the strength of the bulbs; however the light intensity must be strong enough to cause a low initial Fv/Fo reading. In some embodiments, the light source is within one inch of the samples up to approximately three feet above the samples. Both ends of this range of distances generate good results. In one embodiment, the light source intensity will be monitored continuously using a photosynthetic photon flux sensor.

The light exposure treatment can be performed, for example, over a range of about 1.0, 2.3, 3.1, 4.8, 5.4, 6.9, 7.0, 8.2, 9.7, 10.8, 15.3, 20.4, 25.0, 30.6, 40.5, 45.4, 50.7, 60.4, 70.5, 80.9, 90.0, 100.5, 110.7, 120.0 or more minutes, including any integer or fraction thereof. In one embodiment, the period of time is 15 to 20 minutes. Acceptable results can be obtained with a shorter or longer exposure time, but depend heavily on plant type and light history. In one embodiment, when comparing a plant grown in heavy periods of shade with one grown in full sunlight, long periods of light exposure are required, potentially greater than 15 minutes.

In another embodiment, a plant light is used. In one embodiment, the leaf samples are exposed to light for a period of about fifteen minutes. This exposure to light assures that each leaf sample is light adapted for chlorophyll a fluorescence testing. In one embodiment, at the end of the period of light exposure, the light is removed and the rest of the test is performed in a dark environment.

### Fluorescence Measurement

In some embodiments, once the dark environment is established, a fluorometer is used to measure the fluorescence values of each leaf sample. The equipment used in the embodiment discussed in Example 4 was an OS1-P Portable Modulated Chlorophyll Fluorometer from Opti-Sciences, Inc. However, other suitable fluorometers from various manufacturers can be used. Exemplary manufacturers which supply equipment for chlorophyll fluorescence measurement include, for example: Li-Cor (Lincoln, Nebr. USA 68504-0425) supplies the Licor-6400XL which can integrate chlorophyll fluorescence and gas exchange to provide an array of data measurements; Opti-Sciences, Inc. (Hudson, N.H., USA), which supplies several types of fluorometers; Photon Systems Instruments (PSI) (Brno, Czech Republic), which supplies chlorophyll fluorescence measurement systems; Heinz Walz GmbH (Effeltrich, Germany) which supplies fluorometers and custom solutions for customers; and Hansatech Instruments (Pentney, King's Lynn, Norfolk PE32 1JL England), which produces chlorophyll fluorometers and provides the fluorometer technology for PP Systems (PP Systems International, Inc., Amesbury, Mass., USA).

In one embodiment, the fluorescence measurement process is repeated periodically to observe the chlorophyll a fluorescence values over a period of time. In one embodiment, the measurement can be repeated every 5 minutes over a total period of thirty minutes. However, the measurements can be performed as often as is suitable for a particular experiment—for example, from less than about every 0.5 minutes, every 1 minute, every 1.5 minutes, every 2 minutes, every 3 minutes, every 4 minutes, every 5 minutes, every 7 minutes, every 10 minutes, every 13 minutes (including all integers and fractions thereof), or more. The process allows the leaf samples to become fully dark-adapted and provides a steady-state condition of each leaf sample at its test temperature per its location on the temperature gradient table. The test period can continue for a time from about 15 minutes to about 1 hour, or more. For example, the total test period can be from less than about 15 minutes, 20 minutes, 25 minutes, 30 minutes, 35 minutes, 40 minutes, 45 minutes, 50 minutes, 55 minutes, 60 minutes, 70 minutes, 80 minutes, to about 90 minutes (including integers or fractions thereof), or more. In one embodiment, the total testing period is about 30 minutes.

In one embodiment, a CNC x/y table can be used to place the fluorometer head over each leaf sample. The use of this type of automation requires less manpower, and can often be more accurate and repeatable than using a hand-held fluorometer.

In one embodiment, during the collection of the chlorophyll a fluorescence measurements, the temperatures of each area of the temperature gradient table, or, alternatively, temperatures of the sample plates, if used, are collected so that each chlorophyll a fluorescence reading can be coordinated to the exact temperature of the leaf sample at the time of chlorophyll a fluorescence measurement. The temperature gradient plate can be monitored during the testing procedure so that the temperature varies as little as possible.

In one embodiment, the chlorophyll a fluorescence readings are collected and organized by sample. The value of Fᵥ/Fₒ can then be determined and plotted over time using a line graph, or otherwise manipulated mathematically. Various approaches can be used to create appropriate data sets for each leaf sample on the temperature gradient plate. In one embodiment, the mean and standard deviation can be determined for the multiple leaf samples of one plant cultivar that are collected at each temperature.

BIOTIC experimental design experiences a 2 to 3 degree fluctuation over the period of testing. Due to the nature of the temperature control apparatus an extremely precise temperature control and monitoring system is required to acquire and maintain the desired testing environment. As defined by the research published by Dr. John Burke the method utilizes electric current to manipulate the temperature of ceramic plates via a Peltier type device. Without adequate control, a temperature variation of 2 to 3 degrees Celsius over the course of the experiment thus limiting the range of accuracy.

Testing showed that temperature fluctuations occurred in part from the saturation light. In one embodiment, by adding a clear plastic covering between the bare light bulbs and the sample material, the fluctuations can be reduced to below 0.5 C, during the period of testing.

In one embodiment, in order to control the environmental factors', including ambient temperatures, affect on the temperature gradient plate, the temperature gradient plate is insulated with spray foam insulation underneath and on all four sides. In one embodiment, for the top surface of the plate, a rubber gasket mat was also machined to only expose the portions of the plate required to be accessible on the thermal gradient plate to limit environmental factors.

In one embodiment, the temperature gradient table is allowed to equilibrate for at least 24 hours prior to testing to minimize changes during testing. In one embodiment the time for equilibration can be 30 minutes, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 or more hours, including any integer or fraction thereof.

In one embodiment, the thermal plate also incorporates the use of defined testing areas of less than one inch square. The location is monitored historically with the thermal history recorded to capture and quantify any thermal changes without external stimuli.

In one embodiment, individual thermistors are placed at each sample location, which will record the temperature of the sample each time a measurement occurs. This removes the bias created by taking the measurements after the interval of testing and allows for the error in the process to be limited to only the repeatability of the measuring instrument. Using the temperature of the sample and the fluorometer reading gathered at the same time allows for the determination of a true accuracy without bias.

In one embodiment, the actual measurement and recording of the test reading is given over to the control of an automated system. This method guaranteed all measurements are taken at the same angle and for the exact amount of time allowing for increased repeatability.

In one embodiment, all repeated measurements are taken at the exact location of all previous measurements. This ensures that all repeated measurements are taken in locations that have the same concentration of photosystem II sites as all previous measurements. Thus, ensuring that repeated measures are not biased by variations in the plant material.

In one embodiment, the measurement process has been further expanded to incorporate the use of an automated data capture software, which records, categorizes, and stores all measured data within a single user accessible database. The automated data capture software includes a user interface which allows for the addition of historical significant data that could include but is not limited to, specie or genotype information, testing time and date, equipment identification codes, operator information. In one embodiment, the software can store information only during the time of testing or maintain an ongoing data collection throughout the day even during times when the equipment is not in use.

### Calculation of the OPCT

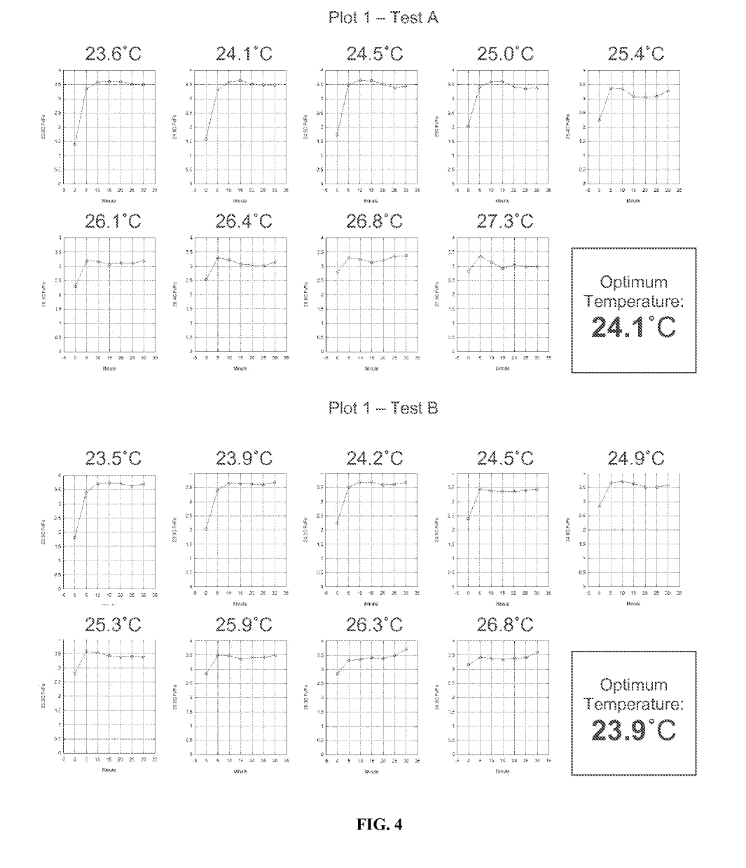

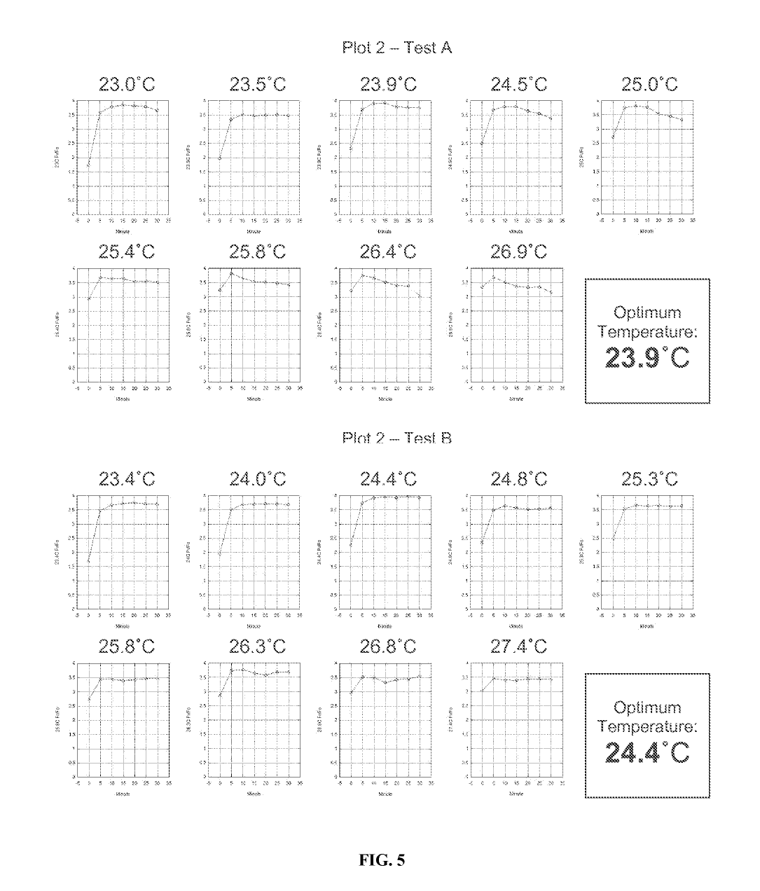

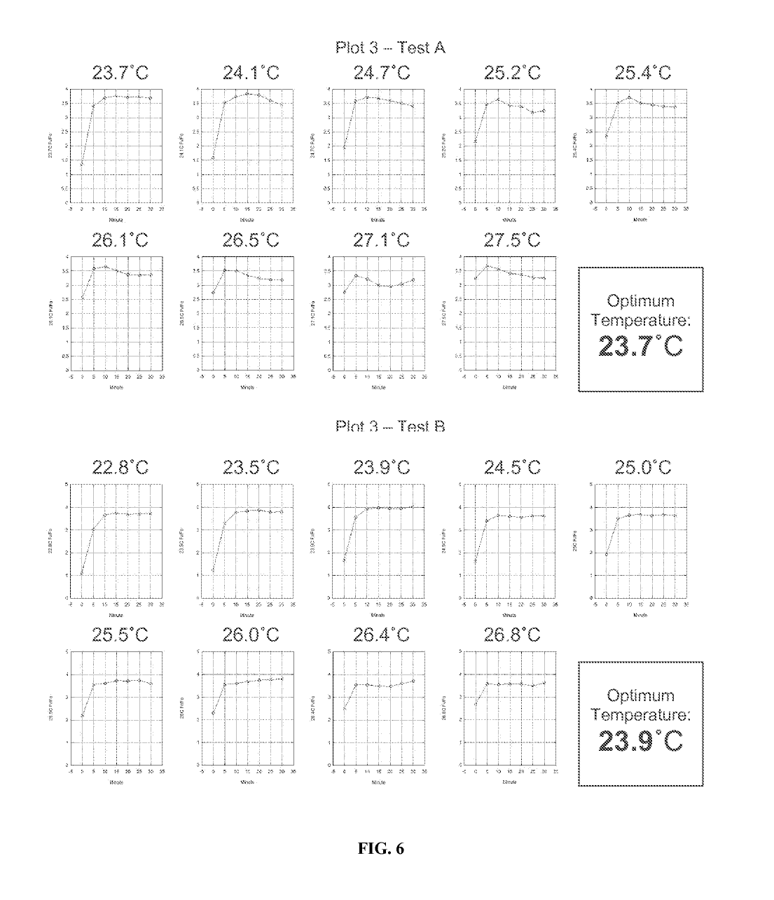

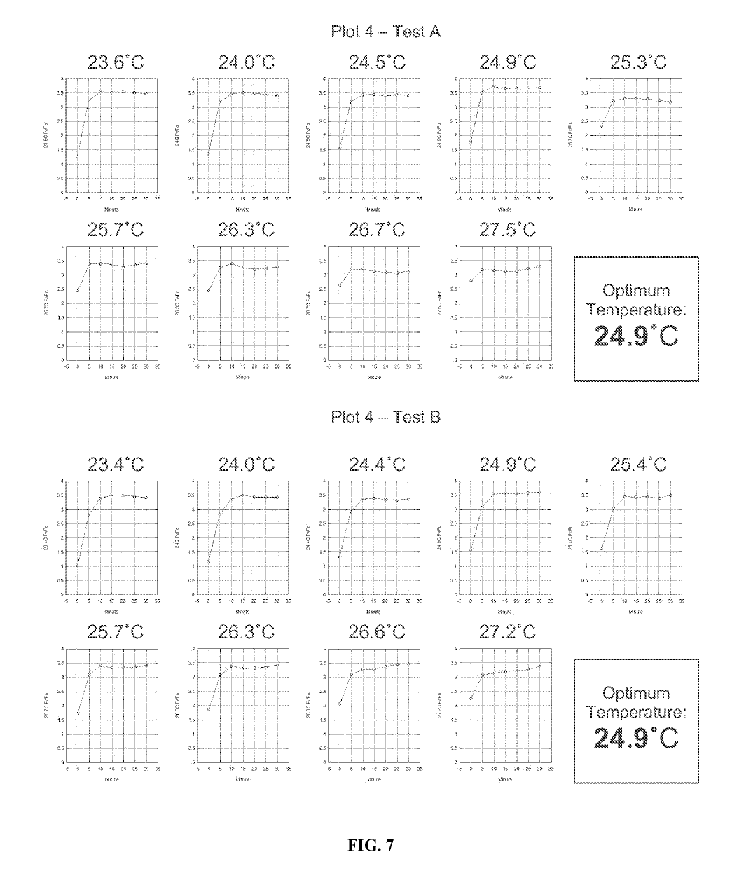

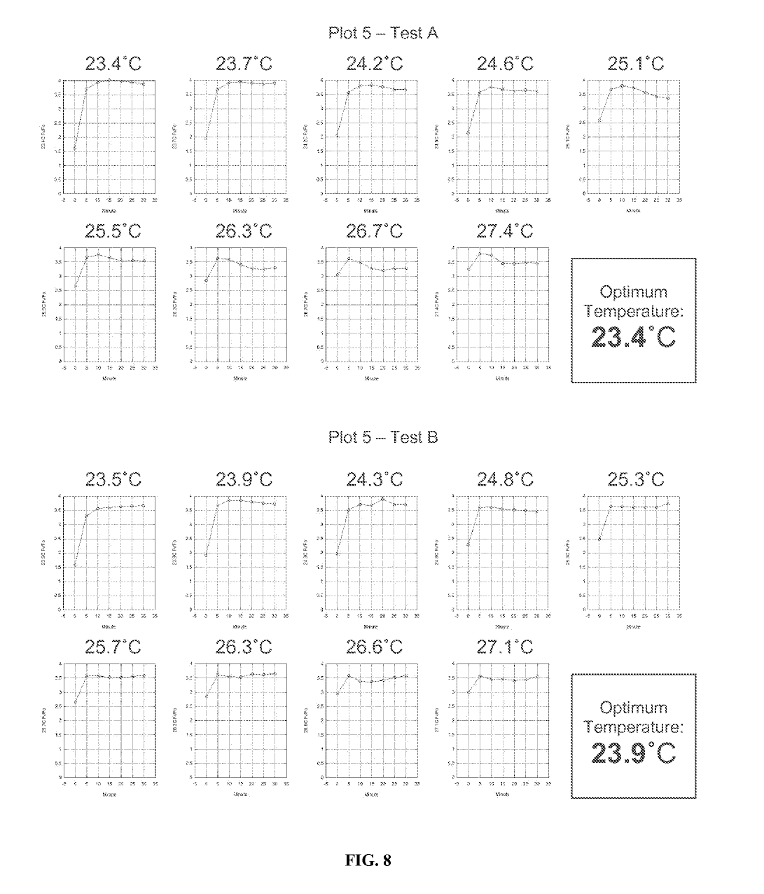

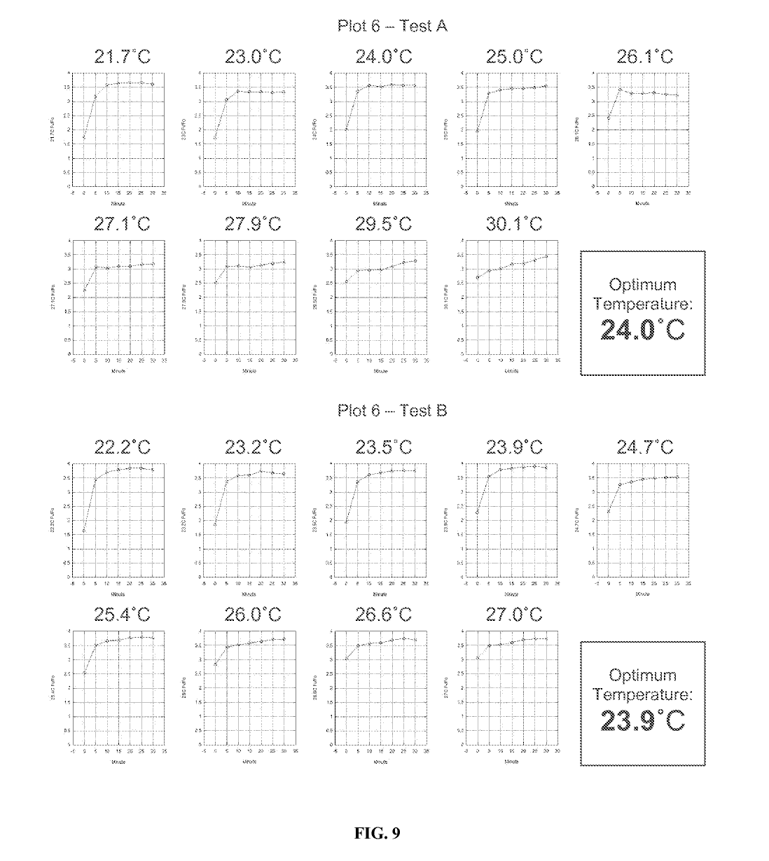

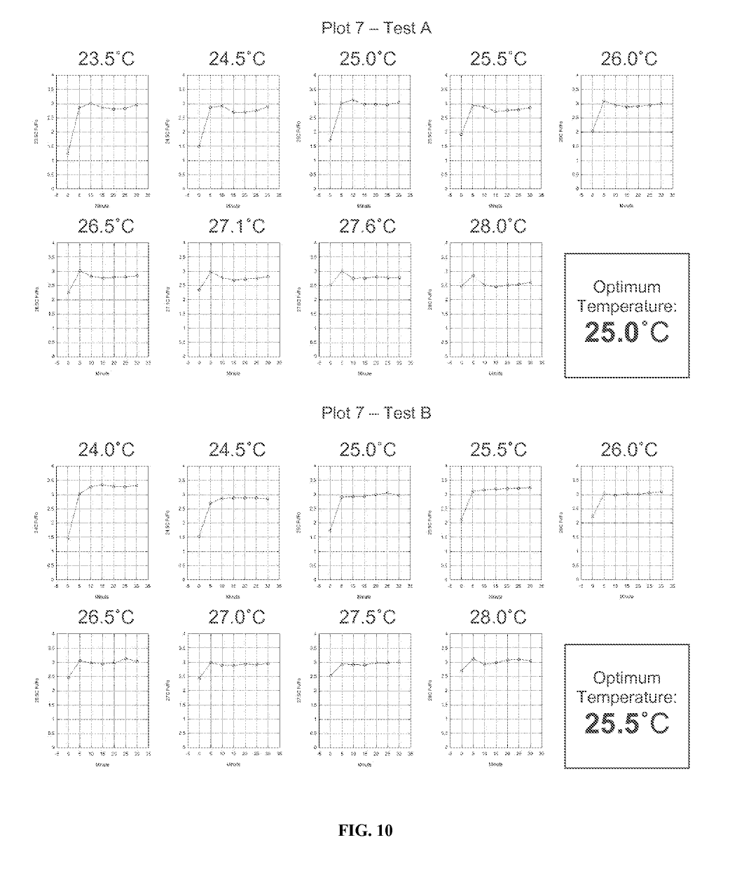

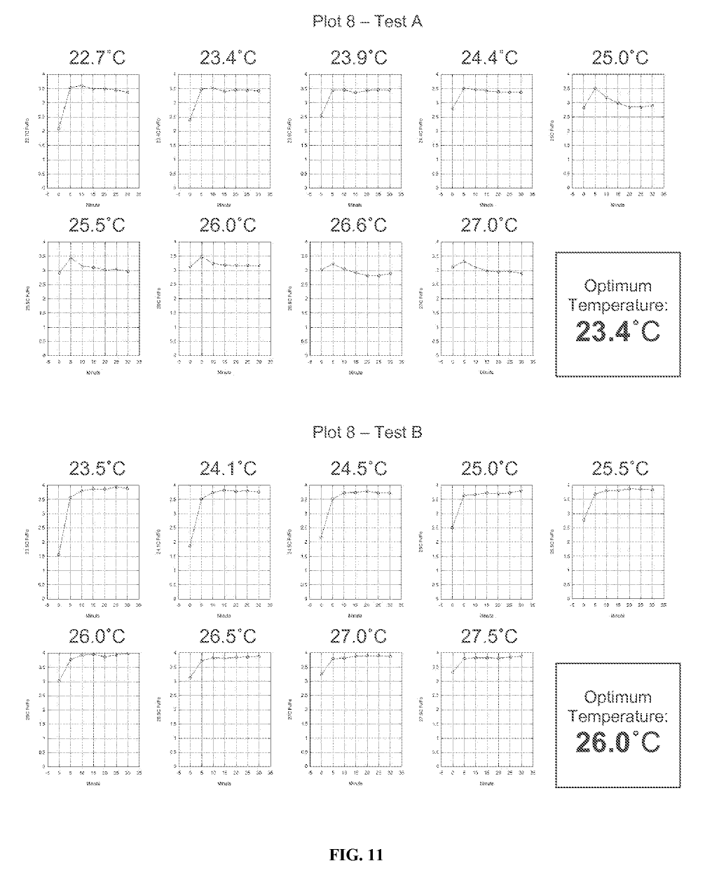

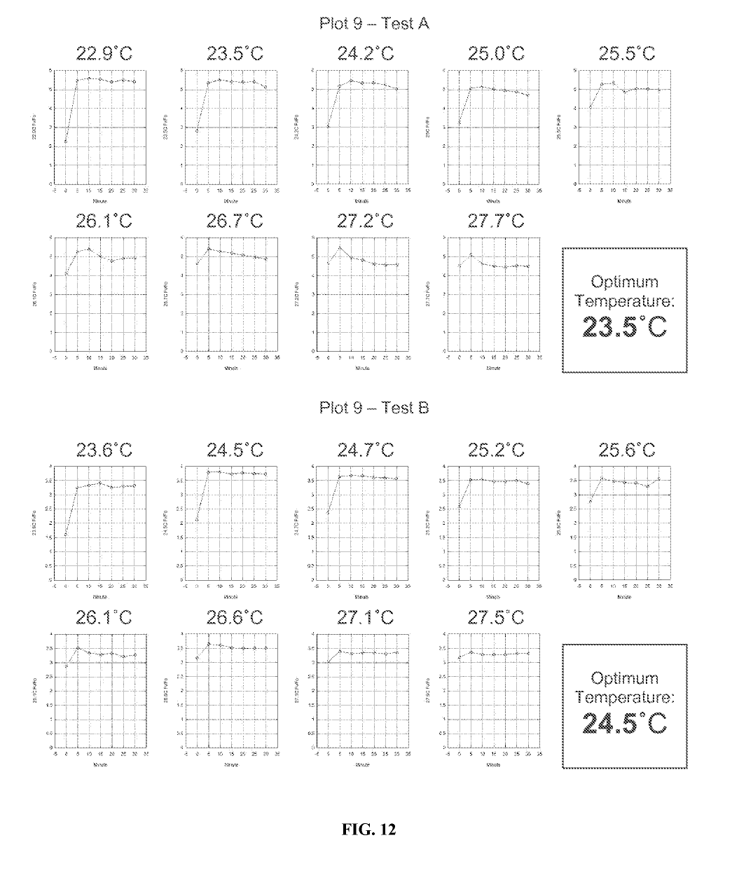

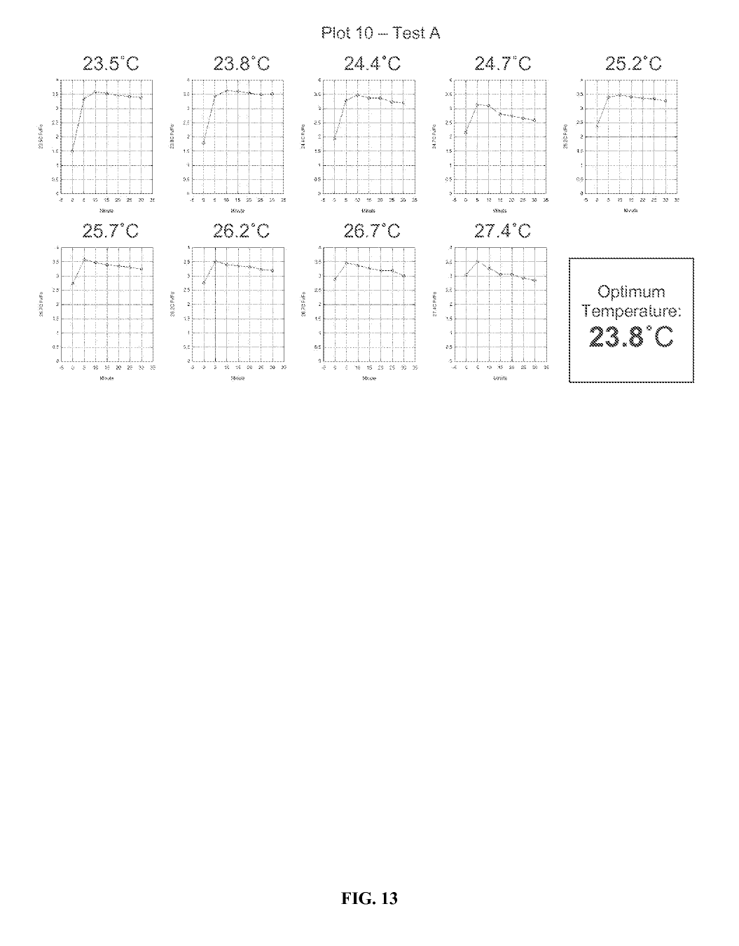

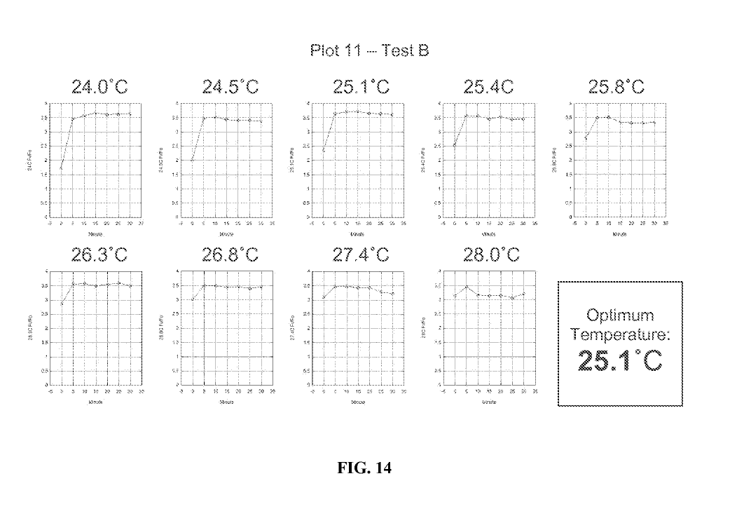

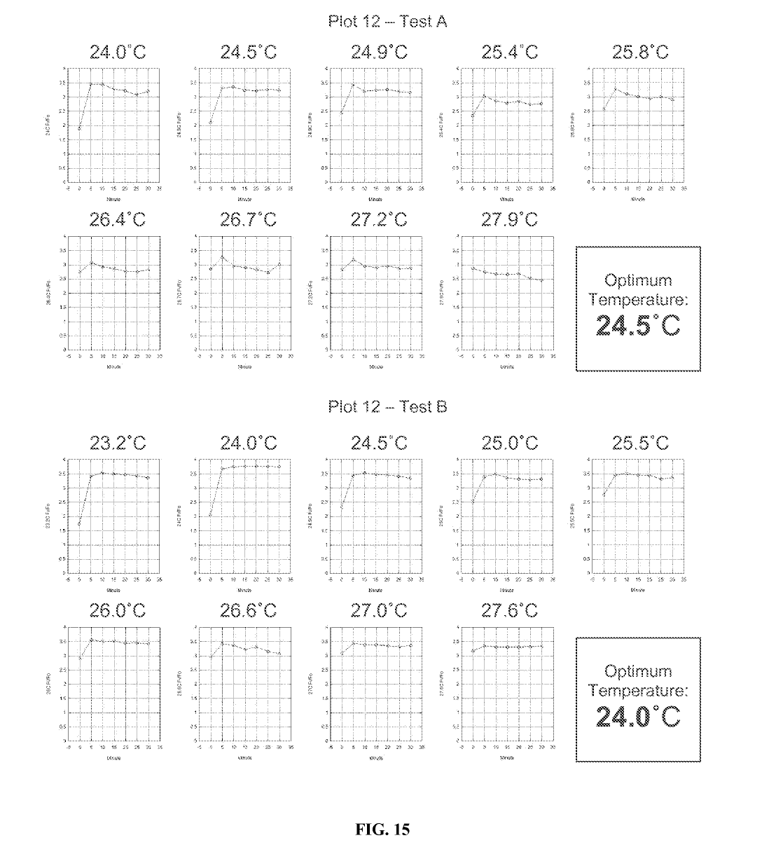

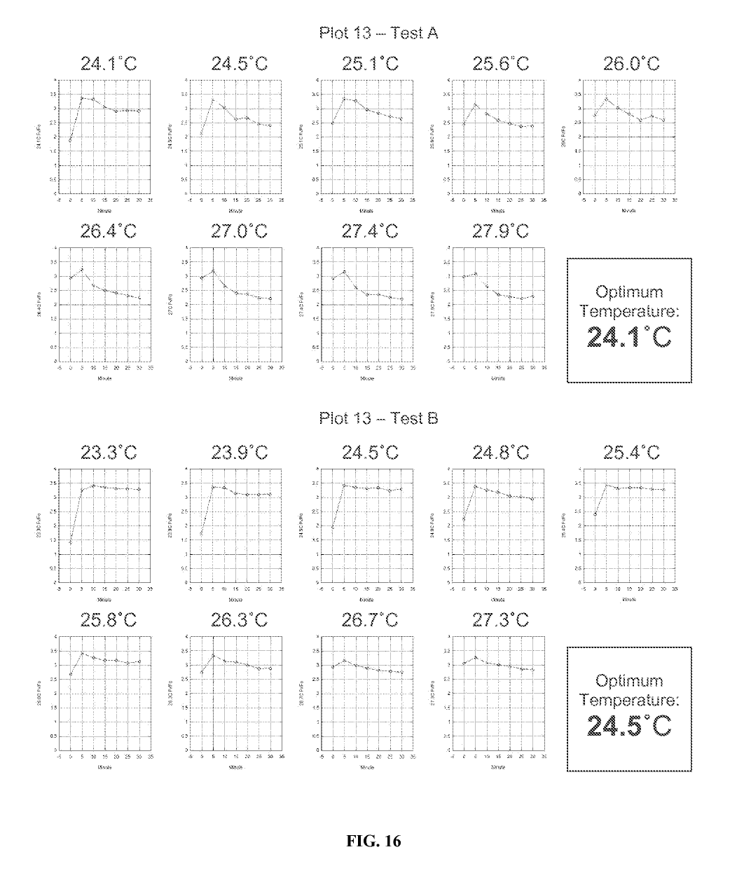

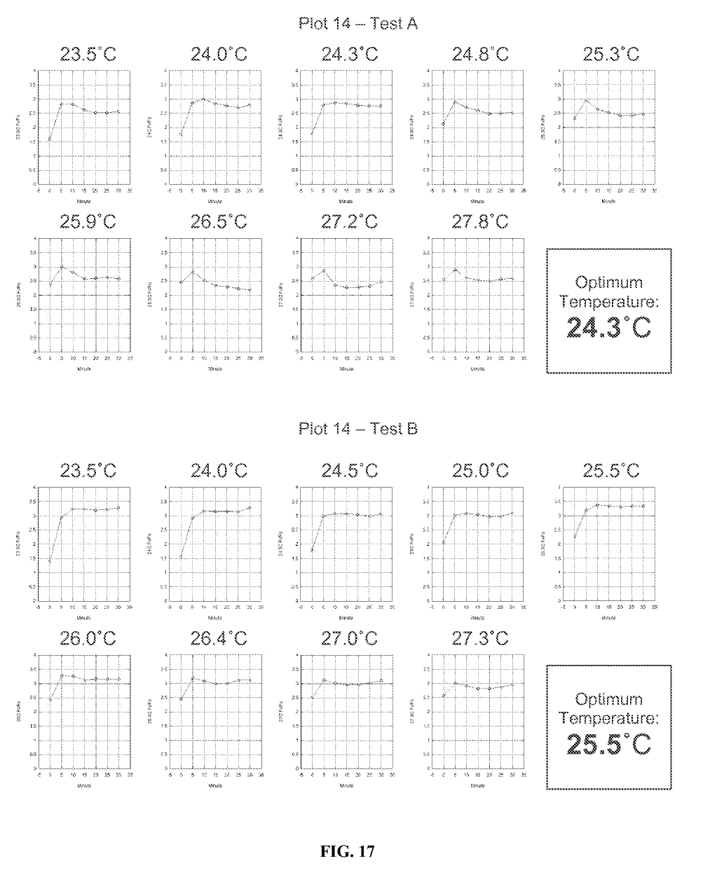

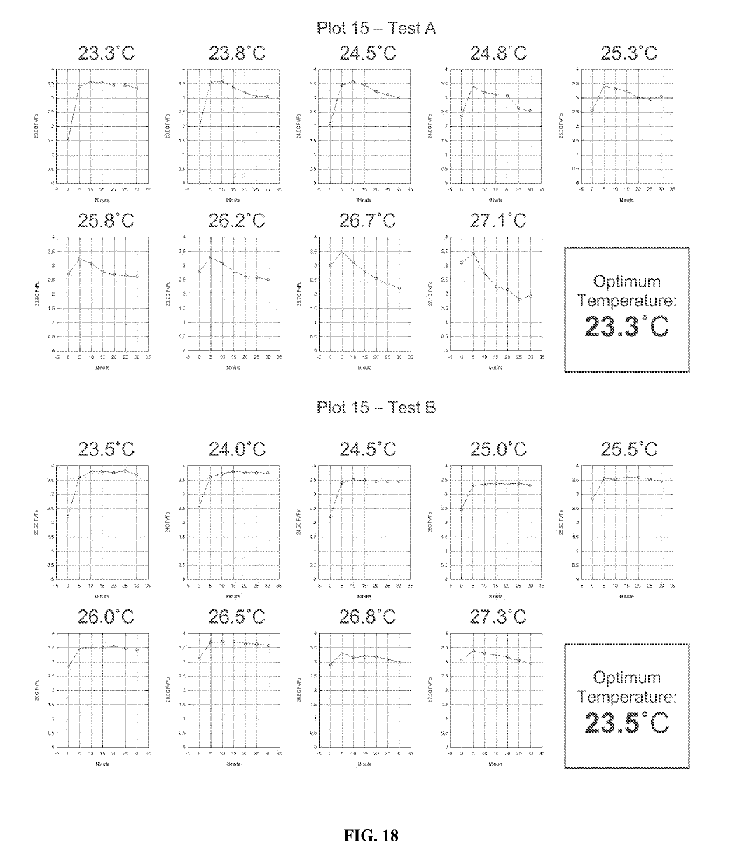

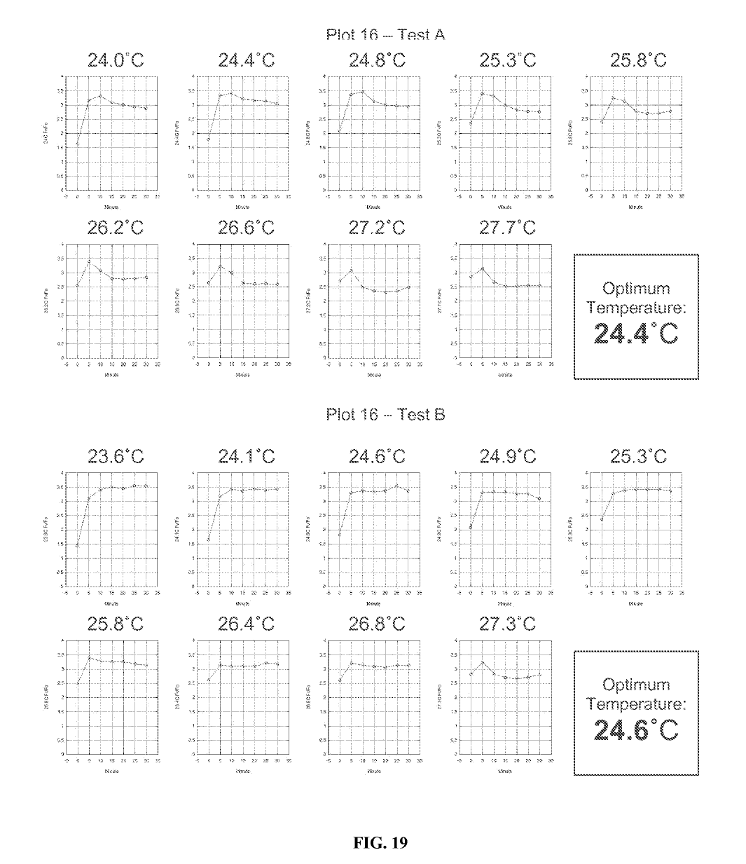

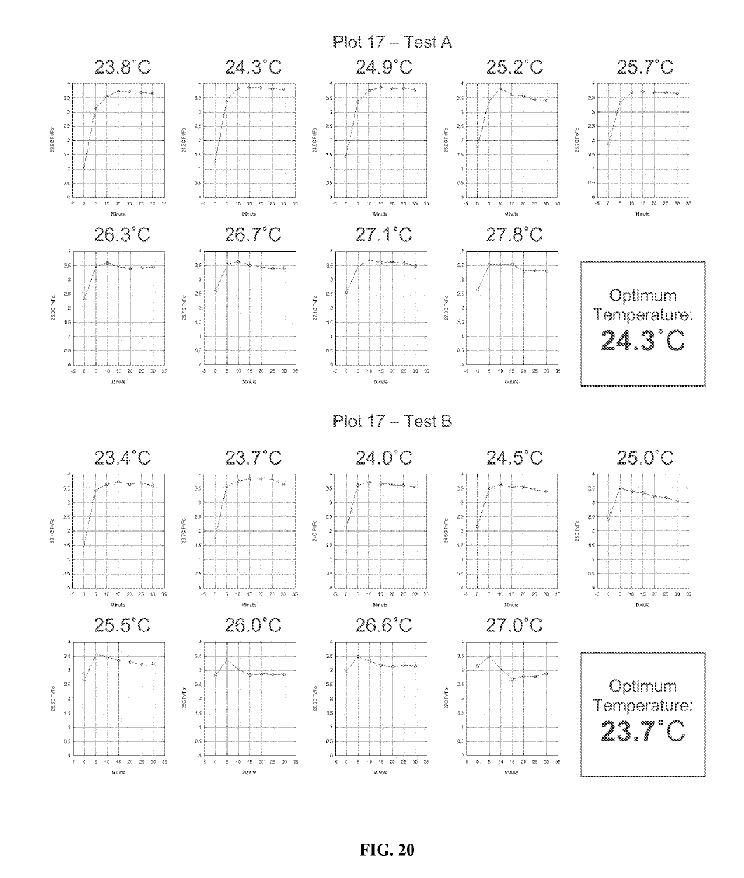

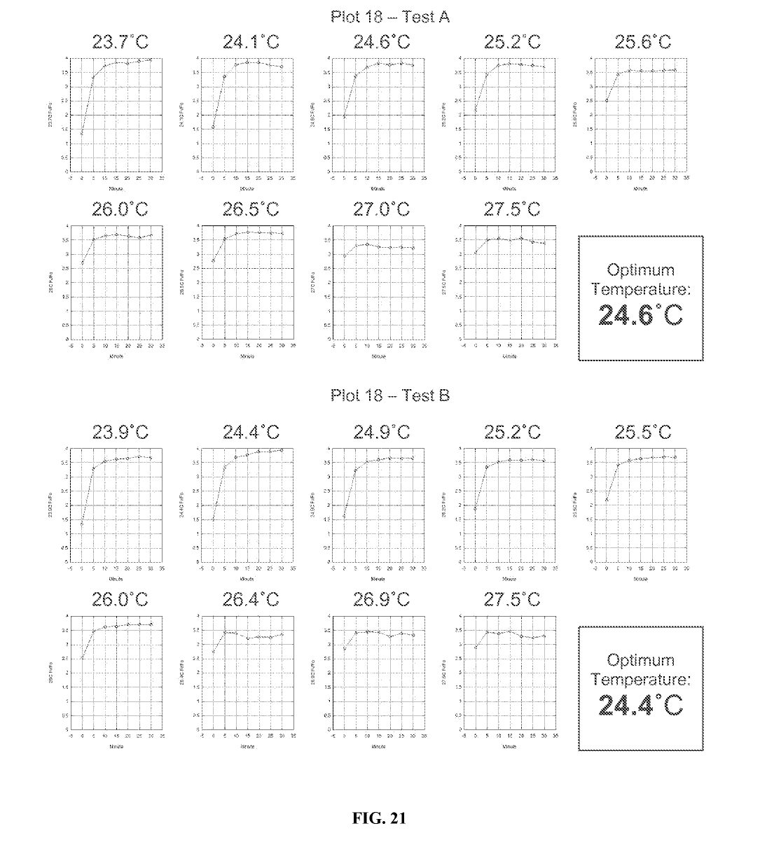

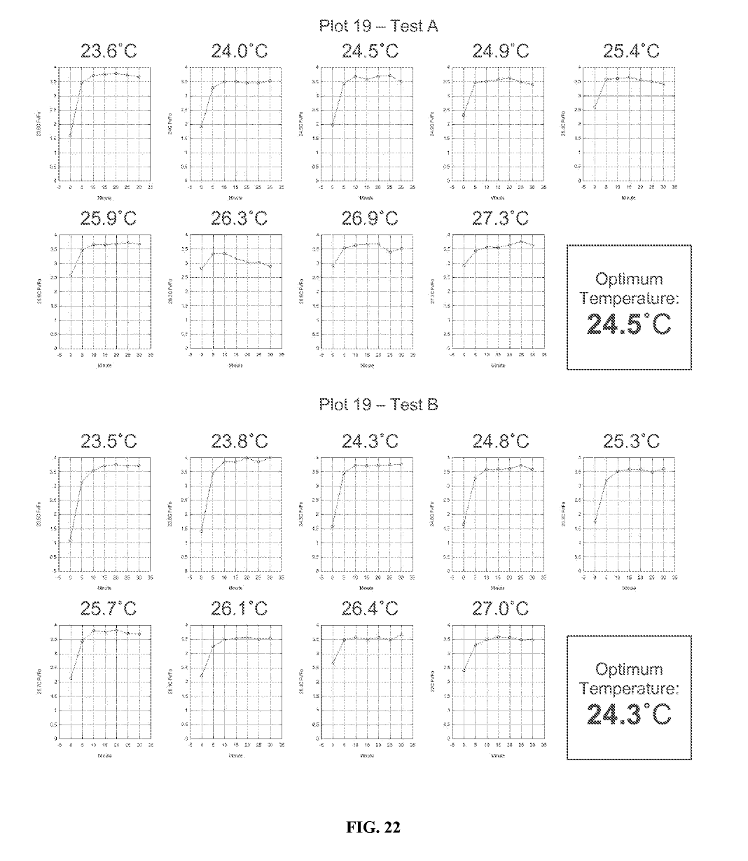

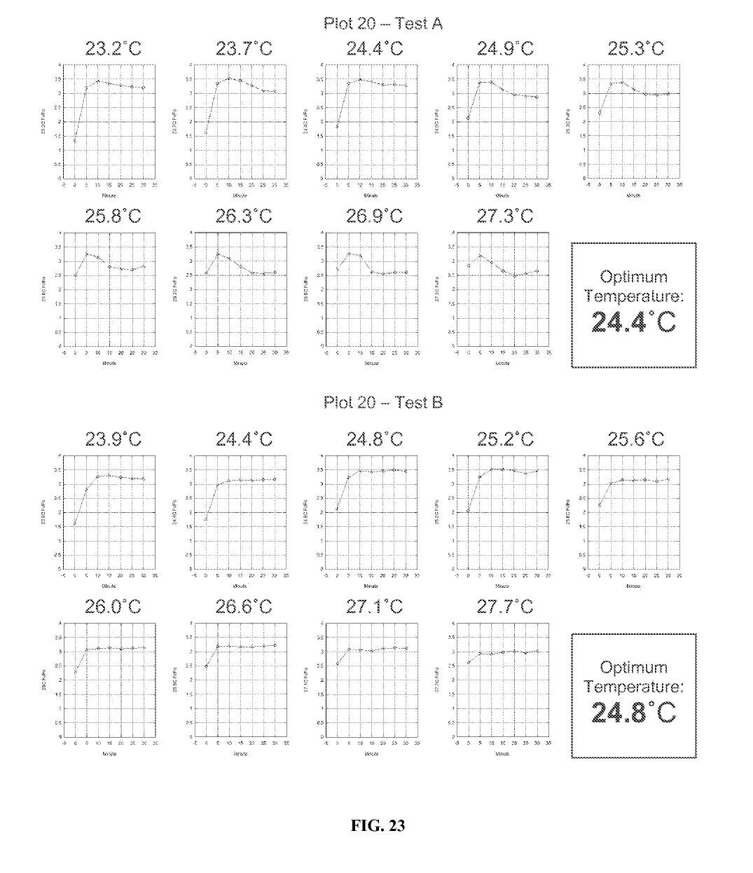

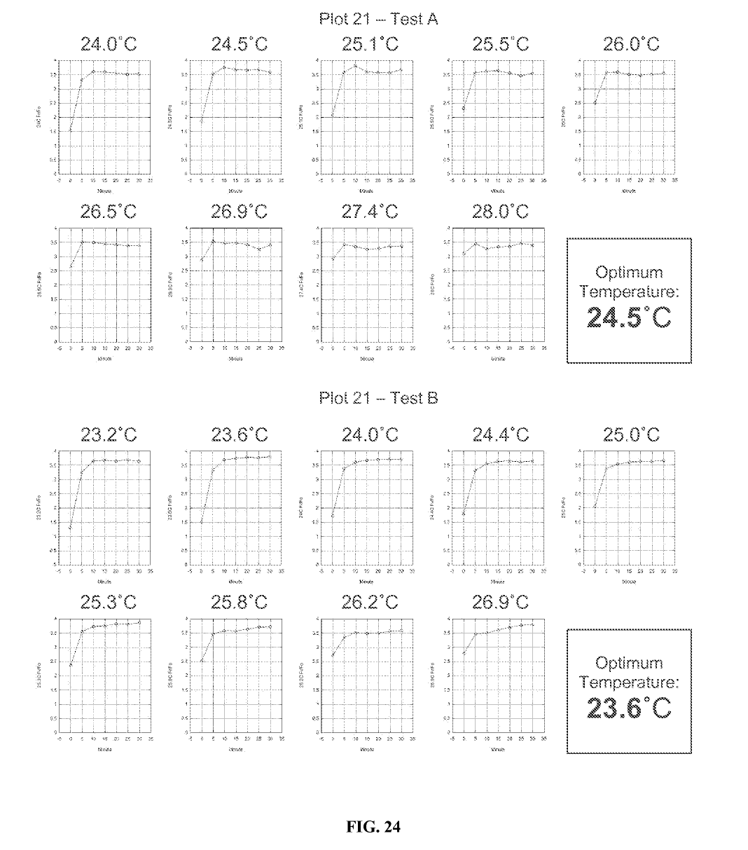

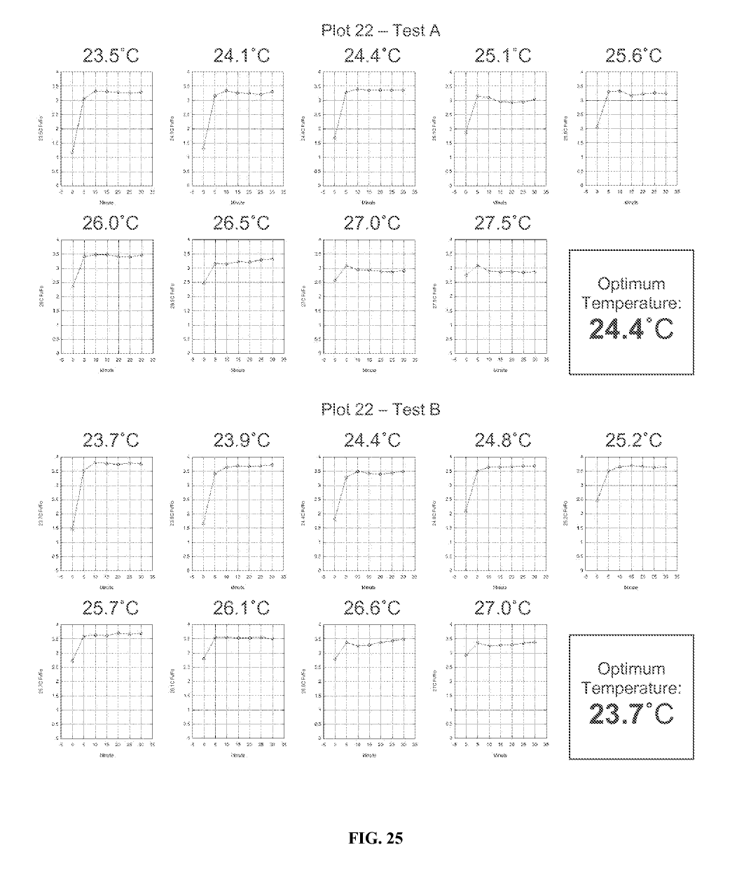

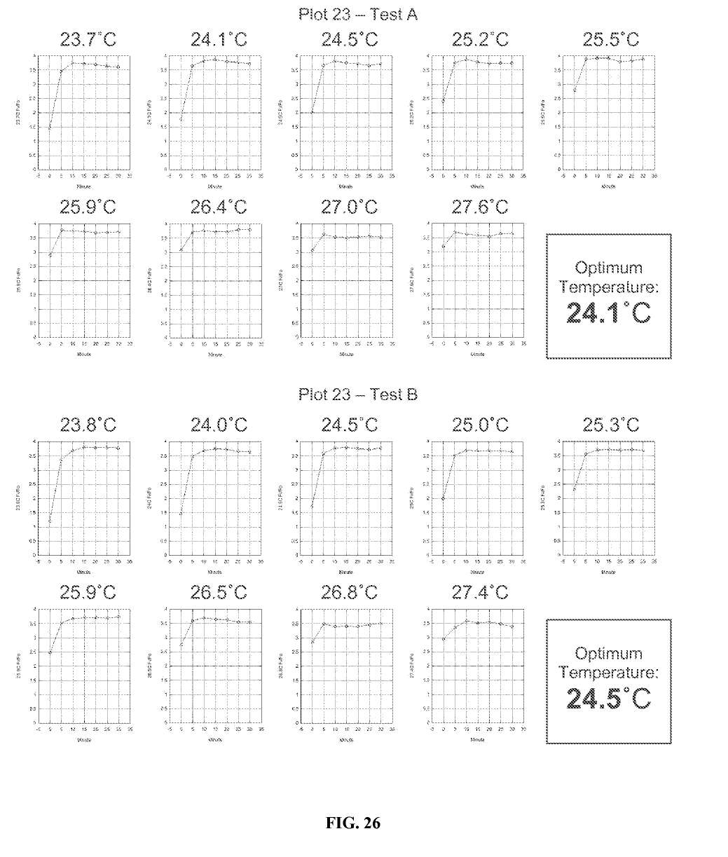

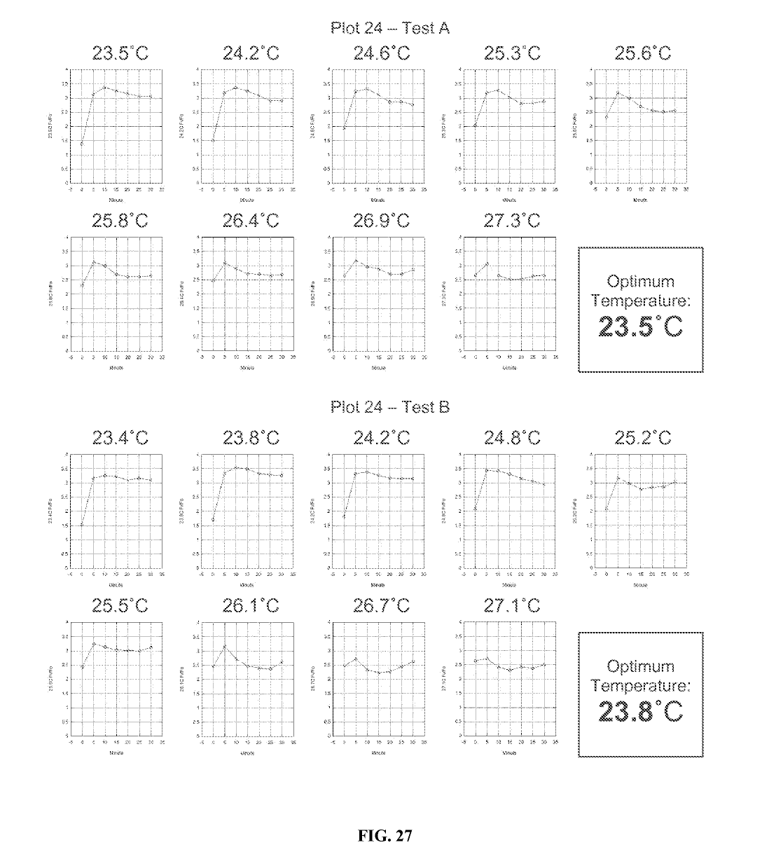

The fluorescence data can then be evaluated and the Fv/Fo can be determined. A graphical plot of each of the different temperatures can be prepared for each sample plant. Examples of these graphs are shown in FIG. 4 through FIG. 27. These graphs plot Fv/Fo over a 30 minute time period, with a separate graph for each temperature.

As used herein, the term Fs is used to indicate the value of Fv/Fo. This value is a general indicator of plant physiological health. By measuring this physiological indicator over a range of temperatures, the optimum temperature of a specific leaf sample occurs at the temperature with the best Fv/Fo performance (Burke, J. J. (1990), Plant Physiol. 93:652-656).

According to Burke (1990), the evaluation of the Fv/Fo line graphs involves the subjective examination of three characteristics of each graph:

a quick rise of Fv/Fo in the first five minutes;

a high Fv/Fo value at 5 minutes; and

a flat slope from 5 minutes to 30 minutes.

These characteristics can be evaluated by visually observing the line graphs of Fs (that is, Fv/Fo) over time. The characteristics can also be evaluated by creating a mathematic model that provides a numerical value, where a higher number is associated with the qualitative improvement of these three characteristics.

In one embodiment, the curstolics are defined as a set percent decrease in the optimal performance. In one embodiment, the curstolics represent a 10 percent decrease in optimal performance. In one embodiment, the curstolics may represent a 5, 6, 7, 8, 9, 10, 11, 12, 13, 14, 15, 16, 17, 18, 19, or 20 percent decrease in optimal performance.

FIGS. 4 through 27 show the Fs graphs of twenty-four different cultivars for rice and hybrid rice along with the mathematical model as described in Examples 4 and 5.

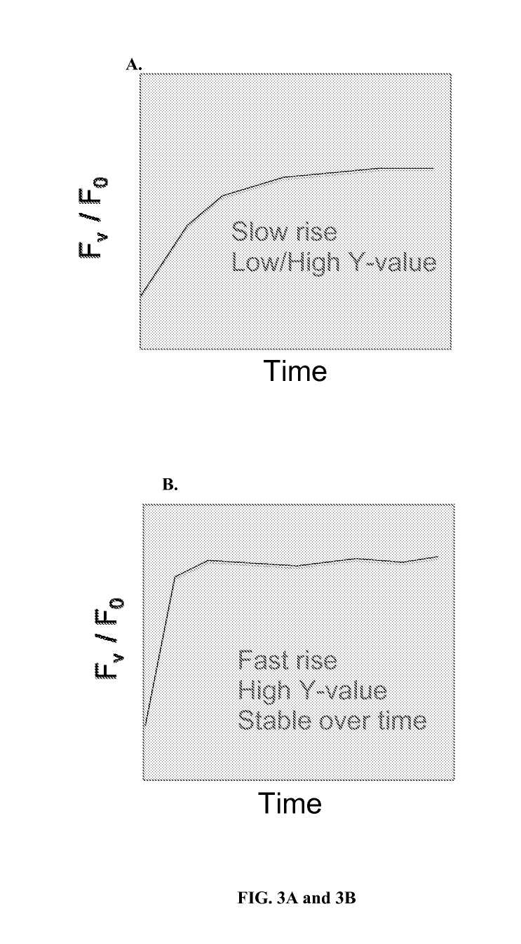

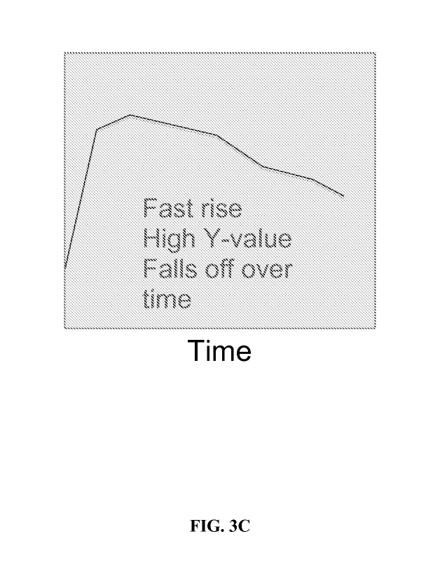

FIG. 3 displays typical response curves for below optimum (FIG. 3A), optimum (FIG. 3B), and above optimum (FIG. 3C) leaf temperatures. When the leaf is at a temperature below the optimum, the value of Fv/Fo at about 5 minutes tends to be low (see FIG. 3A). At leaf temperatures above the optimum, Fv/Fo tends to have a high 5-minute value but tends to have a non-stable slope from 5 minutes to 30 minutes (see FIG. 3B).

### Computer System

In one embodiment, a computer system is used to collect the data. In one embodiment, the computer system processes the data to determine the OPCT and/or curstolics. In one embodiment, the computer system is connected to the fluorometer such that it can collect data from the fluorometer. In one embodiment, the computer system is connected to the heat sensors in the gradient table such that the computer system is capable of collecting data from the heat sensors. In one embodiment, the computer system is connected to a robotic arm or other positioning mechanism such that the computer system can record the position of the fluorometer at the time of reading. In one embodiment, the computer system is capable of sending signals to the robotic arm or positioning system to move to a specific position for taking a reading on the table. In one embodiment, the computer system is connected wirelessly to the robotic arm, fluorometer, table or other components of the systems described herein.

In one embodiment the computer system contains a set of instructions for processing the obtained data to determine the OPCT and/or curstolics.

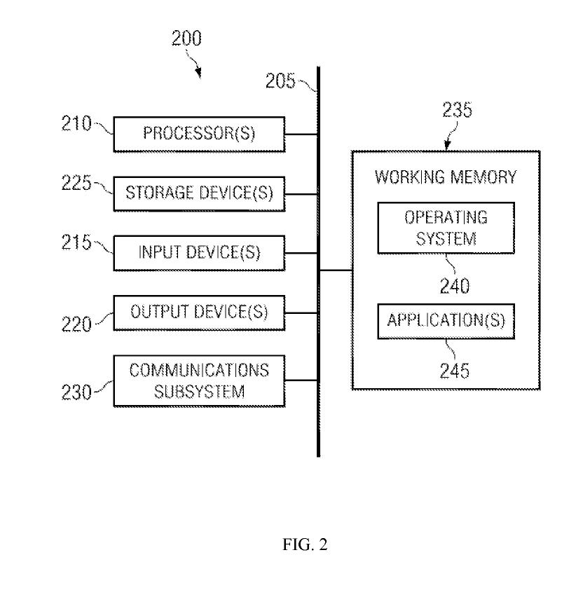

The computer system 200 is shown (FIG. 2) comprising hardware elements that can be electrically coupled via a bus 205 (or may otherwise be in communication, as appropriate). The hardware elements may include one or more processors 210, including without limitation one or more general-purpose processors and/or one or more special-purpose processors (such as digital signal processing chips, graphics acceleration processors, and/or the like); one or more input devices 215, which can include without limitation a mouse, a keyboard and/or the like; and one or more output devices 220, which can include without limitation a display device, a printer and/or the like.

The computer system 200 may further include (and/or be in communication with) one or more storage devices 225, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 200 might also include a communications subsystem 230, which can include without limitation a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 230 may permit data to be exchanged with a network (such as the network described below, to name one example), with other computer systems, and/or with any other devices described herein. In many embodiments, the computer system 200 will further comprise a working memory 235, which can include a RAM or ROM device, as described above.

The computer system 200 also may comprise software elements, shown as being currently located within the working memory 235, including an operating system 240, device drivers, executable libraries, and/or other code, such as one or more application programs 245, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 225 described above. In some cases, the storage medium might be incorporated within a computer system, such as the system 200. In other embodiments, the storage medium might be separate from a computer tem (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer system 200 and/or might take the form of source and/or installable code, which, upon compilation and/or installation on the computer system 200 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 200) to perform methods in accordance with various embodiments of the invention. According to a set of embodiments, some or all of the procedures of such methods are performed by the computer system 200 in response to processor 210 executing one or more sequences of one or more instructions (which might be incorporated into the operating system 240 and/or other code, such as an application program 245) contained in the working memory 235. Such instructions may be read into the working memory 235 from another computer readable medium, such as one or more of the storage device(s) 225. Merely by way of example, execution of the sequences of instructions contained in the working memory 235 might cause the processor(s) 210 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 200, various computer readable media might be involved in providing instructions/code to processor(s) 210 for execution and/or might be used to store and/or carry such instructions/code (e.g., as signals). In many implementations, a computer readable medium is a non-transitory, physical and/or tangible storage medium. Such a medium may take many forms, including but not limited to, non-volatile media, volatile media, and transmission media. Non-volatile media includes, for example, optical and/or magnetic disks, such as the storage device(s) 225. Volatile media includes, without limitation, dynamic memory, such as the working memory 235. Transmission media includes, without limitation, coaxial cables, copper wire and fiber optics, including the wires that comprise the bus 205, as well as the various components of the communication subsystem 230 (and/or the media by which the communications subsystem 230 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 210 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 200. These signals, which might be in the form of electromagnetic signals, acoustic signals, optical signals and/or the like, are all examples of carrier waves on which instructions can be encoded, in accordance with various embodiments of the invention.

The communications subsystem 230 (and/or components thereof) generally will receive the signals, and the bus 205 then might carry the signals (and/or the data, instructions, etc. carried by the signals) to the working memory 235, from which the processor(s) 205 retrieves and executes the instructions. The instructions received by the working memory 235 may optionally be stored on a storage device 225 either before or after execution by the processor(s) 210.

### Agricultural Management

In one embodiment, the OPCT and/or curstolics obtained from the method described can be used in combination with computerized agricultural management systems, such as those described in co-pending U.S. patent application Ser. No. 13/294,857.

Crop canopy temperature can be correlated with the overall health of the crop. Much in the way a human operates most effectively when the body is kept in an optimum temperature range, so does a plant. As a result, technology has responded with various devices to measure a crop's temperature. As an example, infrared sensors are now used to measure crop canopy temperature, giving an effective indicator of the plant's leaf temperature.

In some embodiments, it may not always be prudent for a grower to intervene, for example, to irrigate, just because of an isolated crop canopy temperature that is above optimum. In some embodiments, the grower needs to know what effect his management decision will have on his ultimate bottom line. For example, it may not be economical to spend money to irrigate a crop even if its canopy temperature has been above optimal for an extended period of time if the crop is only mildly stressed and has not been subjected to significant stress over the growing season. To make prudent management decisions, the grower needs sophisticated data with triggers so the grower can better determine the cumulative amount of stress that a crop has been subjected to and what effect this stress will have on yield.

In some embodiments, it is instructive for the grower to have at his disposal a way of knowing not only whether his crop was above its optimum growing temperature or optimal canopy temperature on any given day, but also for how long the crop was above the optimum growing temperature or optimal canopy temperature and to what ranges above optimum the canopy temperature climbed. This data can then be analyzed in light of crop specific parameters. Tracking this information, analyzing the collected data, and reacting with a responsive watering plan can drastically affect ultimate crop yield. This data, when providing the grower with triggers for action, helps the grower determine when it might be a waste of resources to intervene because the intervention might not significantly impact the final yield. For example, if a crop's optimum temperature is 82° F., as is generally the case with cotton, then it is instructive to know not only whether the plant has been subjected to higher temperatures than the optimum, but also for how long and in what range the higher temperatures occurred.

Crops subjected to temperatures well above optimum, for longer periods of time, resulted in far less desirable yields. Crop yield was found to be more closely correlated to the cumulative amount of stress that the crops were subjected to as compared with the crop temperature or overall time the crop was being stressed. In some embodiments, utilizing this information proves a powerful tool for a grower in that he will know when to timely intervene to lower crop temperature, using interventions such as irrigation. The same approach may be used with regard to other agricultural management decisions (including but not limited to predicting future yield, as well as the timing and application of pesticides, growth regulators, growth hormones, herbicides, and the like) and is not limited to determining the timing and application of irrigation.

The disclosed method and system has proven greatly beneficial to plant breeders, growers, researchers and agricultural consultants, in that the collected data can be used to characterization of plant varieties, select optimum genetic varieties, predict outcomes and adjust management styles.

### Devices for Measurement

In an embodiment, several devices that can measure and collect crop canopy temperature, such as an infrared thermometer, or other suitable canopy temperature measurement device, are placed at intervals throughout the field. The devices can be programmed to collect temperatures at specific timed intervals which may be as often as every 5 minutes or any interval of time desired. The devices may be set, for example, to collect temperatures at intervals from about every 15 seconds, 30 seconds, every minute, 2 minutes, 4 minutes, 6 minutes, 10 minutes, 15 minutes, 30 minutes, 45 minutes, or 1 hour or more. Several readings can be averaged into one data point, if desired. In an embodiment, 1 minute readings are taken and averaged every 15 minutes into a single data point.

In an embodiment, at least one device that can measure the ambient temperature is also placed in the field. Concurrently, ambient temperatures and other weather data can be collected in the field at timed intervals. Alternatively, ambient temperature and weather data can be collected from other sources. In an embodiment, the device that measures the canopy temperature is also the device that measures the ambient temperature. The data collection can be analyzed, for example, every 30 minutes, every hour, every 2 hours, every 3 hours, every 6 hours, every 12 hours, every 16 hours, every 24 hours, or more, if desired. In some embodiments, the data is relayed by any suitable means, such as by using cellular or another radio frequency transmission, to a microprocessor or to a web server for storage and analysis. In some embodiments, the transmission antenna for each device can be located so as to minimize interference from the crop as well as to avoid interfering with any irrigation equipment.

### Data Analysis

In an embodiment, the disclosed invention includes software that analyzes and plots the collected canopy temperatures, ambient temperature, and the specific crop's optimum growing temperature or optimal canopy temperature against time, in order to generate a crop yield predictor, a crop health indicator or a crop maturity indicator determined from the overall accumulated stress of the crop. The information received from the crop, or “input data”, can be analyzed using a number of mathematical models such as the calculations described herein, in order to determine the amount of crop stress, and whether an irrigation decision or other management decision should be made. The collected data from the field, as well as the resulting information from the crop stress calculations, can be remotely obtained, if desired, by logging into a web server.

In some embodiments, the microprocessor or web server has preloaded data containing relevant known optimum temperatures for the specific crop being monitored. The known optimum temperature can be determined using, for example, the BIOTIC method described in U.S. Pat. No. 5,539,637, the content of which is incorporated herein, or any of the methods described herein.

In an embodiment, selective data such as predetermined trigger alerts can be transmitted directly to the grower via cell phones, text messages, email alerts, voicemail alerts, SMS alerts or other communication methods. This information can then be used by the grower to make crop management decisions, such as irrigation timing and amount. In some situations, the trigger alert should be acted upon immediately. Accordingly, the trigger alerts can also be arranged to be sent to an automated irrigation control device or a remote irrigation control device. The alert can also be sent to another entity. Exemplary entities to receive an alert can include, but are not limited to, an agricultural management service, an agricultural insurance company, a crop investment group, a local water authority, an irrigation organization, another requested entity, and the like. In one embodiment, the user may request that the system run in a “silent mode” wherein no trigger alerts are sent. In one embodiment, the “silent mode” may be for a predetermine period of time.

In an embodiment, an information summary or update of the crop information can also be sent to the grower or other entity as often as desired, even if no alert has been triggered. The information summary can be sent, for example, every 30 minutes, hourly, twice daily, daily, weekly, monthly, or longer. The information summary can be sent by any suitable means. Exemplary methods of sending the information summary include but are not limited to email, cell phone, phone message, pager, text message, internet access, website display, instant message, or other system, as desired.

In some embodiments, also preloaded is algorithm-controlled software that is capable of plotting the ambient temperatures and the crop canopy temperatures against length of time at a given temperature.

In an embodiment, the ambient and crop canopy temperatures are plotted against the optimum growing temperature or optimal canopy temperature of the given crop. These plots can be used to identify when the crop has been subjected to predetermined cumulative amounts of stress. The plots and algorithms can also be used to generate triggers to identify and easily visualize when a grower should optimally intervene with additional irrigation in order to reduce crop stress and to maximize crop yield in an economical fashion.

### Crop Stress—Data Analysis Methods

Several data analysis methods can be used to determine the level of crop stress and to calculate a numerical trigger to alert the grower. Three methods that can be used are discussed below: 1) dividing the stress into “layers” or “stress level groups” to better determine the degree of heat damage the leaf is experiencing; 2) the “Smartfield Stress Index”, which factors in both leaf temperature and ambient temperature; and 3) the “Accumulated area stress count”, which is the area under the curve of the leaf temperature but above the optimal temperature for an amount of time (this method factors in both the elevated temperature and the time at that temperature).

Data Analysis Method 1): Separate the Observed Canopy Temperature into Discrete Stress Level Groups (Such as by Normal Growth, Normal Stress, High Stress, and Extreme Stress) Based on the Degrees Above Optimal

In an embodiment, a method for determining accumulated temperature stress involves rating the temperature a crop canopy is experiencing into several discrete groups, in order to better characterize the degree of heat stress the crop is experiencing. In an embodiment, the discrete groups are: non-stressed (that is, normal growth, crop at optimal canopy temperature), normal stress, high stress, or extreme stress. This range can be different for different plant types, and can be determined by several means, such as, for example, by the previous experience of the grower, by reviewing the literature, by examining historical crop data, or by other means. In this method, the temperatures above optimal growing temperature or optimum canopy temperature are plotted in a series of discrete levels (rather than simply listing the observed canopy temperature) over a period of time. The different levels can be color coded, or can be otherwise coded, on a graphical representation to allow easy visualization of the stress level the crop has experienced. The resulting graph displays the length of time that a crop has experienced various discrete levels of temperature stress, as determined by how high the canopy temperature is in relation to its biological optimum.

Cotton can be used as a general example. Cotton plants generally have a biological optimum of 28° C. (82° F.). Thus, normal or “optimal” growth occurs at 28° C. At this crop canopy temperature, the plant is not temperature-stressed (“normal growth”). When the crop canopy temperature exceeds 28° C., the cotton plant is considered to be experiencing some degree of temperature stress. When the canopy temperature is between 28° C. and 30° C., the cotton plant is experiencing “normal stress”. High stress for cotton crops can be defined, for example, as any amount of time the canopy temperature exceeds 30° C. (86° F.), and extreme stress can be defined, for example, as any amount of time the cotton crop canopy temperature exceeds 33° C. (91° F.). When visualized on a graph, these different discrete levels can be color coded or pattern coded so that one can easily see when the crop is or has been at a dangerous temperature stress level.

For different crops, the optimum growing temperature and optimum canopy temperature can be different, as well as the temperature settings for normal stress, high stress, and extreme stress.

In some embodiments, the method is very flexible, so that the individual growers can set the triggers for an alert as they desire.

These discrete temperature stress level settings can also be adjusted based on empirical data on crop yield for a particular field or similarly situated fields over subsequent growing seasons. These settings may also be adjusted for economics, such as the expected value of additional crop yield as compared to the production cost associated with that yield increase. The settings may also be adjusted as needed at different times in the plant life cycle. For example, sensitive growth periods, such as germination, flowering, fruit set, or fruit/crop maturation may require changes in the discrete temperature stress settings, depending on the crop. The algorithms then calculate accumulated stress time which can be used to measure crop health, irrigation needs, other input needs, crop status and to project yield based on the trends reflected in the graphs.

As an example of the different discrete temperature stress groups that a grower might assign to different crops, for example, see the table below.

TABLE 2
Examples of the use of different stress range
settings for different plant types

| | | Normal | | | |
|---|---|---|---|---|---|
| | | Growth | | | |
| | Optimal | (non- | Normal | | |
| Plant | Temperature | stressed) | Stress | High Stress | Extreme |
| type | (° C.) | (° C.) | (° C.) | (° C.) | Stress (° C.) |
| A | 28 | ≦28 | 28-30 | 30-35 | >35 |
| B | 26 | ≦26 | 26-28 | 28-30 | >30 |
| C | 27.5 | ≦27.5 | 27.5-28 | 28-32 | >32 |
| D | 23 | ≦23 | 23-27 | 27-28 | >28 |
| E | 30 | ≦30 | 30-32 | 32-37 | >37 |

In some embodiments, knowing this information enables the grower to decide whether to irrigate or initiate other management decisions, whether corrective action is needed in the field and what the appropriate action would be. For example, the data may indicate that a crop lingering at a certain level above optimum growing temperature or optimum canopy temperature range for a certain period of time may not create sufficient stress to significantly decrease crop yields. As a result, perhaps intervention with water in that scenario would be unwarranted and would even be a wasteful action. The disclosed method and system removes subjectivity and emotion from the watering decision and gives the grower critical objective data on which to base his crop interventions, including triggers indicating when action is advised.

In some embodiments, for example, a trigger for an alert to the grower can be sent when the plant is at “high stress” for greater than an hour; but a trigger for an immediate alert to be sent to the grower whenever the plant is experiencing “extreme stress”.

In an embodiment, the grower can arrange the system so that during early growth, even a “normal stress” of about 30 minutes is a trigger to alert the grower to irrigate, while later in the growth cycle, the system can be altered so that a trigger occurs only after several hours of heat stress.

Because the system is very flexible, the grower can arrange the system so that an alert is triggered after any amount of time and/or temperature stress, and from any chosen algorithm or mathematical model.

Thus, an alert trigger can be set, for example, when a crop reaches the “high stress” group for 30 minutes, or 1 hour, 2 hours, 3 hours, 4 hours, 6 hours, or 8 hours, or more. Similarly, an alert trigger can be set, for example, to notify the grower or turn on irrigation when a crop reaches the “extreme stress” range group for more than 15 minutes, more than 30 minutes, or 1 hour, 2 hours, 3 hours, 4 hours, 6 hours, 8 hours, or more. An alert trigger can be set, for example, when a crop canopy temperature is in the “normal stress” group for a certain amount of time, such as for 4 hours each day for 3 days, or 2 hours each day for 2 days, etc. For plants that may be particularly heat sensitive, the alert trigger can be set, for example, to alert the grower when the plant is at “normal stress” for more than a certain amount of time, such as, for example, 1 hour, 2 hours, 3 hours, 4 hours, or more.

### Data Analysis Method 2): Smartfield Stress Index

In another embodiment, an alternative mathematical model for determining accumulated crop stress can be used. The calculation for this method is somewhat more complicated; it factors in not only the crop canopy temperature, but also the ambient temperature. This method has been named the Smartfield Stress Index or “Stress Index”. In this method, a Riemann sum method is used to calculate 1) the area under the canopy temperature and above the optimum growing temperature or optimum canopy temperature for the crop; and 2) the area under the ambient temperature and above the optimum growing temperature or optimum canopy temperature of the crop. For each period of time, for example, each day, the following equation can be used to quantify the plant's performance and condition:

[(Area under canopy temperature but above optimum canopy temperature/Area under ambient temperature but above optimum temperature)−1]×100]

In some embodiments, using the Stress Index, values of −70 and less result in improved yield and improved water efficiency. For a plant with little or no stress, the Stress Index will approach—100. As the Stress Index approaches a value of zero, the plant loses its ability to cool itself using available water. At a value of zero, the plant has no ability to cool itself. At values greater than zero, the canopy is actually hotter than the ambient temperature. This is an extreme stress condition for the plant. In an embodiment, the calculated Stress Index score number is used to determine the crop health. In another embodiment, the stress index score is further divided into discrete levels, such as, for example:

100=no stress (normal growth);
100 to −70=normal stress;
70 to 0=high stress; and
0 and above=extreme stress.

This stress index can be adjusted as needed, such as according to each crop, stage of crop growth, and crop sensitivity to temperature stress.

In some embodiments, the grower may have predetermined that based on studies of effect on yield and other variables he wishes to intervene only when the plant is experiencing high or extreme stress levels, as opposed to normal stress levels. The disclosed method and system enables him to, in real time, determine whether the plant is at a stress level that triggers a management decision.

In one embodiment, the length of time the plant was above optimum temperature during a 24 hour period is multiplied by the average of the temperatures collected above optimum. The plant's canopy temperature can be collected as often as desired. In an embodiment, a reading is taken every minute. In some embodiments, the average temperature above optimum is calculated by fifteen minute slices of data over a 24 hour period. Over the fifteen minutes, if the plant averaged three degrees above optimum temperature, then 15 is multiplied by 3 rendering a stress factor of 45. The grower can then determine at what unit number (or “trigger”) he wishes to initiate a response. In one embodiment, the disclosed invention provides a series of progressively more critical triggers. The grower can then determine at what trigger point to intervene. For cotton grown in west Texas, for example, it appears that daily accumulations of 600 to 800 units of accumulated area provides an optimum result of yield and water efficiency.

In some embodiments, the disclosed method and apparatus puts objective data in the hands of the grower so that the grower can effectively measure crop health, irrigation needs, crop status and predict crop yield, while making informed management decisions. The disclosed method and apparatus gives the grower triggers that indicate when a management decision or action is prudent versus when such an intervention may not make a profound difference in ultimate crop yield or desired crop characteristics.

### Data Analysis Method 3): “Accumulated Area” Stress Count

In a third data analysis method, the observed canopy temperature is plotted throughout the day, and compared to the known optimal temperature for the crop. The amount of time that the crop is above the optimal temperature, multiplied by the degrees above the optimal temperature (thus, the “area under the curve”) is determined at intervals throughout the day, and this data is accumulated throughout the day. When the accumulated area stress count reaches a certain pre-determined number, a trigger for an alert can be sent out to irrigate the crop.

This value is a measure of the accumulated amount of stress the crop has been subjected to over the course of that day. The grower may then take this figure into account in addition to other variables such as the market, energy costs or other variables before determining whether to take action. He may customize his growing plan such that he only intervenes with irrigation if the daily accumulated area total is above the trigger level of 1500, as an example. The system may also be configured to alert the grower when the accumulated area for a particular day exceeds a pre-selected threshold.

In some embodiments, the grower can set the system so that a trigger occurs when a certain total score for the “accumulated area” is reached, but within an hour or a shorter time if the “extreme stress” temperature group is reached. For example, a daily accumulation trigger level of from less than or about 1,000, or about 1,200, about 1,300, about 1,400, to about 1,500, about 1,600, about 1,700, 1,800, 2,000, 2,200, 2,400, 2,600, 2,800, 3,000, 3,200, 3,400, 3,600, 3,800, 4,000, or more can be set so that an alert can be sent when the crop reaches the set number.

In some embodiments, the trigger for alerting the grower is determined from the accumulated stress count, measured over an hour, or a day, or a week, or even during the entire season of the crop. In certain embodiments, the accumulated stress score over the entire life of the plant can be used.

### Setting the Trigger Level by Use of Various Data Analysis Methods

In some embodiments, the grower can be alerted so that he can manually initiate irrigation, either remotely or at the crop location. In some embodiments, the irrigation decision is made automatically, generated from the algorithms of the accumulated temperature and/or time above optimal temperature, as described herein.

In some embodiments, such as when growing a very temperature sensitive plant, or a plant that is in a sensitive stage of its life cycle, the system can be set so that a very low Riemann sum, or a very low amount of time above optimal temperature, is set as a trigger for an irrigation alert.

In some embodiments, the critical temperature for a specific plant type can be determined empirically, or can be predicted, based on knowledge from other plant species, or can be downloaded from a database.

In some embodiments, the grower can base a “trigger” for an alert on predicted yield. For example, if a planned amount of daily irrigation will result in 95 to 100% predicted yield, the grower may wish to set the trigger of 80% yield, so that he is alerted when watering is necessary to prevent a yield that is any lower than the 80% amount. Similarly, a grower can set the trigger for irrigation so that the crop does not get below 85%, 75% 70%, 65%, 60%, 55%, 50%, 45% or 40% predicted yield.

Additionally, in some embodiments, the methods described herein can be used to select for and further characterize optimal plant genetic varieties for growth in certain temperature regimes or in certain water availability regimes. In some embodiments, the method can be used to examine the effects of the introduction of a transgenic sequence or a mutation on plant stress and yield. In some embodiments, the method can be used to examine or characterize the temperature stress responses of progeny from a controlled breeding program. The method can also be used to compare two or more cultivars to determine physiological differences in their response to temperature stress.

### Irrigation

When the alert for a management decision results in the initiation of irrigation, any suitable irrigation means can be used. In one embodiment, the crop is irrigated at a certain pre-determined level per day or week. The trigger alert system is set up for the possibility of the need for additional watering of the crop. In another embodiment, the crop is not automatically watered on a set cycle; instead, the irrigation is initiated only when an alert is sent out.

The irrigation can be controlled, for example, manually, automatically, by remote control, or by other means. The irrigation can be set, for example, as a daily or weekly cycle. The irrigation method can be, for example, drip irrigation, center pivot irrigation, linear move (pivot) irrigation, lateral move irrigation, overhead irrigation, manual irrigation, sprinkler system, a rotary system, or subirrigation. Combinations of irrigation methods can be used.

### Irrigation Districts

In an embodiment, the results of the data analysis, such as the irrigation usage, crop canopy temperatures, accumulated stress count, Smartfield Stress Index, discrete temperature ratings (normal stress, high stress, extreme stress), yields, crop plant stress assessments, and other information can be designed to be accessible by entities or groups including, but not limited to, a specialized water management organization, a government agency, the public, an organization of farmers, an irrigation district, a water district, an association of water users, and the like. In some situations, this gives the grower transparency in the community, so that he is able to demonstrate that he is not wasting water in order to grow his crops. In regions of low water availability, where many types of users may be competing for the same limited water resources, the ability of the grower to clearly demonstrate that he is not wasting water can be an important asset.

Correlation of Temperature Stress with Yield

Yield is correlated to stress, with an increase in accumulated stress time resulting in a reduced yield. In one embodiment, a grower using the disclosed method and system can track yield and stress information over multiple growing seasons and plot whether the expenditures related to the extra water resulted in enough additional yield to warrant the higher costs.

### Programming the Trigger for an Alert for a Certain Predicted Yield of a Crop

In some embodiments, the data analysis methods can include estimates of predicted yield of a crop under certain water deficit conditions. For example, in addition to data analysis based on the observed and optimal leaf temperature, the grower can factor in the predicted yield that would be obtained at certain irrigation levels. For example, the grower can factor in the amount of water he would need to reach a predicted yield level of 50%, 60%, 70%, 80%, 90%, 95%, 98%, or 100% of optimal yield, using any suitable means, such as, for example, available databases, agricultural literature, and his own empirical knowledge of his crop.

The system is set up so that, in years where the water availability is higher, he can change the trigger setting to send an alert when the predicted yield falls below 90%, 95%, 95%, etc., unless irrigation is initiated immediately. Similarly, in seasons of extreme drought in the region, where household needs may become more important than agricultural needs, the grower can set the trigger so that he is alerted only when the predicted yield would go below 50%, or 60%, if he does not water immediately.

In some embodiments, the disclosed method and apparatus reflects a way for growers to be alerted to trigger points based on the level of stress and the time under stress experienced by a crop. Utilizing the disclosed invention, the grower can choose what triggers to take action on, enabling more customization of crop management. As an example, he may wish to make different management decisions based on different triggers, and even based on external circumstances such as, for example, the cost of water, the cost of oil or electricity, the weather, changes in stock prices, changes in transportation costs, changes in crop prices, and the like.

### System for Monitoring Crops

In one embodiment, automated systems for monitoring crop conditions and/or making irrigation decisions known in the art could be modified to perform the methods described above. One such system is described in PCT publication WO 2010/117944, Remote Analysis and Correction of Crop Conditions, which is incorporated by reference.

In one embodiment, the disclosed invention provides a relatively simple and inexpensive method and system for real time automatically and remotely assessing and evaluating crop condition and responding with a management decision. In one embodiment, the method incorporates wired and wireless transmission to collect and transmit the data. In one embodiment, the end user benefits by receiving crop alerts and computerized management decisions on the time interval of his choice. He may choose to execute control commands himself or just receive alerts that changes have been made by the field based controller.

In one embodiment infrared thermometers, plant leaf wetness sensors, leaf thickness sensors and/or dendrometers allow researchers and growers the opportunity to measure more objective and relevant plant characteristics, yet do so remotely by placing such sensors in the field and equipping them with radio chips or other means for data transmission back to a controller.

In some embodiments, the disclosed method and system is able to correlate a one or more variables with known plant parameters, in addition to the determination of stress by monitoring temperature, to determine exactly what a plant's water requirements or other needs are.

As an example, the following characteristics can be collected and analyzed to reach the final irrigation decision. Crop biological characteristics which could be collected include canopy temperature, leaf wetness, stem diameter, leaf thickness, and canopy color. Weather characteristics which may be collected include solar radiation, humidity, ambient temperature, barometric pressure and wind speed.

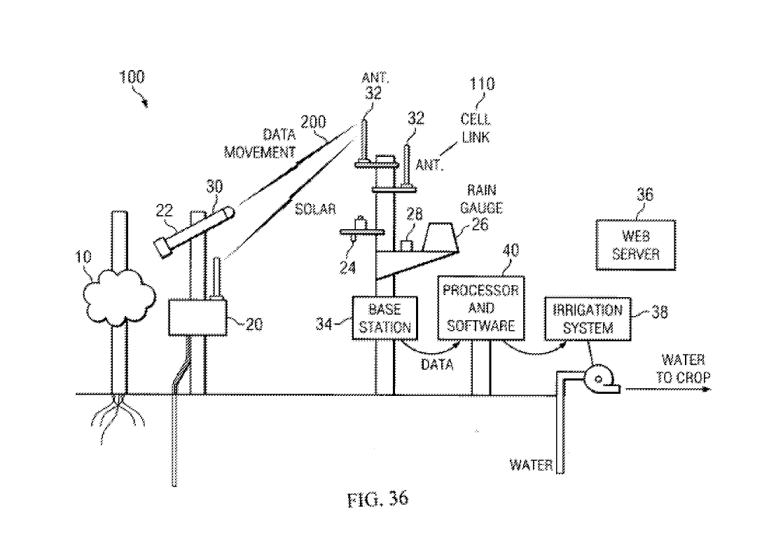

Turning to the figures for illustration, in FIG. 36 is depicted a schematic overview of an embodiment 100 of the method and system. Placed in the crop 10 at desired intervals are a variety of crop sensors which may include, as depicted, a soil moisture sensor 20, or a canopy temperature sensor 22. Also placed in the field, or hardwired to the field base station, are sensors to measure weather characteristics, which may include a solar radiation sensor 24, a rain gauge 26 and a barometric pressure gauge 28. The types of crop sensors used may vary according to the type of crop and the crop characteristics which the grower wishes to measure. Examples of other sensors that may be placed could include sensors or gauges to measure leaf thickness, leaf wetness, wind speed and direction or ambient temperature.

The sensors, for example the canopy temperature sensor 22, may be programmed to take readings on whatever schedule is desired by the grower. In one embodiment, small, lightweight, inexpensive infrared sensors are used. Canopy temperature sensors 22, when used, are placed at a reasonable height to be able to measure the tops, or canopy, of the leaves, depending on the height of the plant. The sensors may be powered by batteries or solar power. The sensors used in the one embodiment have the capability to take readings as frequently as every five seconds. In one embodiment the sensor takes a reading every sixty seconds and hibernates between readings to conserve battery life. In one embodiment, the time interval can be changed with switch settings in the sensor electronics or by software changes. In one embodiment using the sixty second interval, the batteries have been found to last eight to nine months.

In one embodiment, the crop canopy temperature sensors 22 have a built in radio transceiver 30. The readings are transmitted via radio frequency 200 to an antenna 32 located on the field base station 34. At a specified time interval, the crop canopy temperature sensor 22 (or other type of sensor) takes an average of its last several readings and transmits the average to the field base station 34. The field base station 34 can be a receiver (for one way transmission) or may be a transceiver (for two way transmission). In one embodiment, the sensor 22 averages its readings every 15 minutes and transmitted the average.

In one embodiment, the environmental characteristics such as relative humidity, rainfall and air temperature can be measured in the field by sensors or by pods that are hardwired to the field base station. Additional environmental data to assist with weather projections can also be collected and may include barometric pressure or other weather related readings. In another embodiment, environmental data can be supplied from a source external to the system, such as a weather report being supplied from the internet or other computer database.

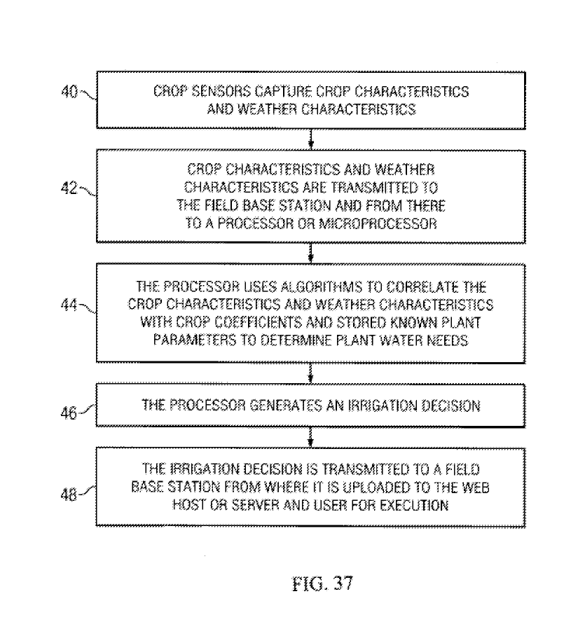

FIG. 37 depicts a flowchart of an embodiment 400 of the disclosed method and system. In the first step 40, the crop sensors capture the crop characteristics and weather characteristics, as earlier described. In the second step 42, the crop characteristics and weather characteristics are transmitted to the field base station and from there to a processor. In step three 44, the processor uses stored algorithms to correlate the crop characteristics and possibly weather characteristics with crop coefficients and/or stored known plant parameters to determine a stress-related need. In step four 46, the processor calculates and generates an irrigation decision. In step five 48, the irrigation decision is transmitted to the field base station 34 from where it is uploaded to the web host or server 36 and transmitted to the end user for execution. The management decision may be manually, automatically or remotely executed, or a report may be generated.

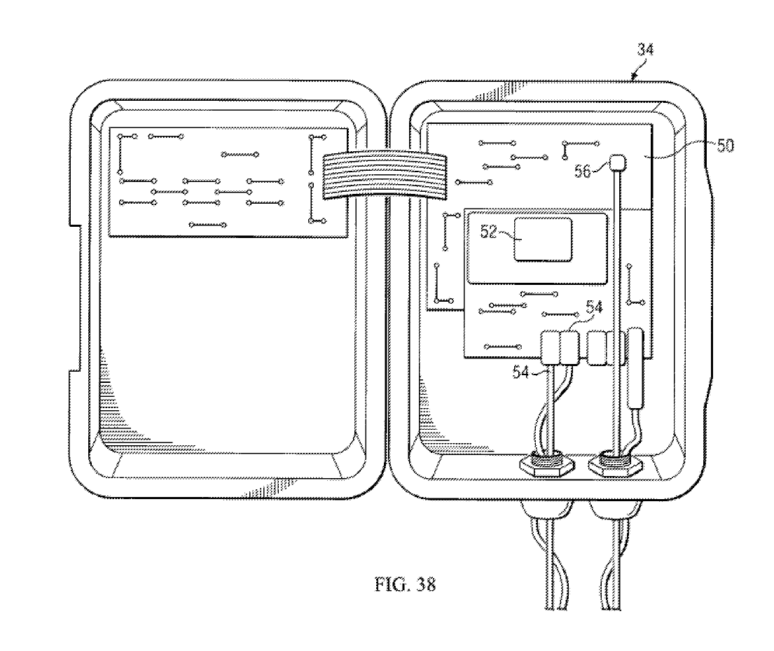

In the embodiment shown in FIG. 38, the field base station 34 contains a motherboard 50, a modem 52, a communications cable 56, and is programmed with a specific IP address. In a one embodiment, at various time intervals, for example every two hours, a remote central computer with a processor or microprocessor and a memory calls the modem 52 and uploads the collected data for storage and processing. The central computer can upload the data to a web host or server 36. The web server 36 can store the data, for reference by the grower. Hardwired into the bottom of the field base station are the weather characteristic sensors, for example the wiring 54 for the rain gauge 26 or others.

Since the field base station 34 has its own IP address, it can be contacted at any time remotely using an internet enabled device. For example, the grower could, from the comfort of his home, access the data in the field base station. In one embodiment, the field base station 34 is also capable of a WiFi connection. In one embodiment, the user may to go out to the field at times and use a data cable to connect their cell phone, PDA or laptop directly to the field base station and access and store readings. In one embodiment, the central computer may be programmed to post status alerts to the website, and/or transmit the message to the end user via cell phone text message, email or other known methods. The end user might receive a message such as the following: “Your crops are currently not in water stress. 0.52” of rainfall has been reported at the site. The method has issued a stop irrigation command. The irrigation is currently off. The method will advise when to resume irrigation.”

As noted in the message above, the central computer can, in one embodiment, simultaneously with the transmission of the message to the end user, also send a control command to the field base station. In one embodiment, the field base station 34 is wired into the irrigation system control panel 38 and can initiate, stop or adjust irrigation schedules as indicated by the control command.

In one embodiment, the grower is able to visit the web server 36 to view the historical data that was collected and used as the basis for the watering decision. He can analyze trends as desired. In one embodiment, the grower can override any decision made by the computer algorithms by manually resetting his irrigation or topical application, or resetting the control panel or choosing specific options on the website. In one embodiment, the method is programmed to transmit any type of relevant management information. For example, the grower may wish to incorporate data pertaining to soil moisture, soil nutrient content, pressure changes of the irrigation method, or other data that a grower would routinely check when visiting the field. In one embodiment, if so programmed, sensors or pods would be placed in the field to relay such data to the field base station 34 for transmission to the central computer and upload to the web server 36. In some embodiments, the grower can check comprehensive parameters and conditions of his crop from various remote locations and can simultaneously send control commands back to the field based controller.

In one embodiment, the central computer is programmed with software containing one or more known plant parameters for biologic characteristics that would be useful in determining whether the plant is stressed. The computer may also be programmed with various known algorithms to calculate plant water needs based on the plant species and stage of growth. In one embodiment, the data is correlated with the algorithms to reach watering decisions using a software program such as SmartDrip™40.

As an example, one algorithm developed by the inventors is as follows:

Irrigation decision (<0=NO: >0=YES)=a(Plant stress time)+b(Canopy temp−optimum temp)+c(sensor input)+d(soil moisture content)+e(cost of water)+f(crop price)+g(water remaining)+h(predicted future high temps)+i(desired yield percentage)+j(desire margin percentage)+k(cost of energy)

The crop coefficients “a” through “k” listed above are specific to crop, growing location, and soil conditions which can be input by the user.

Market conditions and weather forecasts may be crop coefficients as well. To determine whether or not to irrigate is a complicated matter made up of numerous inputs. This equation deals with those inputs by creating a factoring of all inputs to determine a YES or NO irrigation decision. The period of this determination can be varied depending on the physical limitations of the irrigation system. The equation compiles information about the health of the crop, the water status in the soil and the economics of the irrigation decision in regards to input.

The end user may enter data pertaining to the plant's life stage or other variables to assist the computer with its decision. In one embodiment, the application will employ multiple streams of data, including the factors of average stress time for the previous day, or some number of days, measurements regarding the output of the irrigation systems, both time and volume, and predictive factors based on expected weather data, such as forecasted high temperature for the upcoming day, or days to reach its irrigation decision. In some embodiments, the computer software generates an irrigation decision to stop, start or adjust irrigation based on the data, algorithms and predetermined parameters.

In one embodiment, the apparatus will employ three modes of operation: Timer mode, Hybrid mode and Automatic Mode. In one embodiment, in the Timer Mode, the operator can turn irrigation system ON or OFF based on a typical schedule controller. This option can have remote control via Internet connection, but it does not take any input from biological sensors and considers time only control. This mode would be similar to a typical irrigation controller although the currently known controllers lack the remote access via Internet connection disclosed herein.

In one embodiment, in the Automatic Mode the apparatus will use biological and environmental information supplied by Smartfield™ systems (SmartCrop™, SmartWeather™, SmartProfile™ 3X, Sensor Station and others) to schedule irrigation automatically based on the plant's needs and the measured environmental variables, such as ambient temperature or solar radiation. In the automatic mode, each irrigation zone would be activated to run for a period of time calculated off a crop value (for example, the amount of accumulated stress for that particular crop). This value is used in an algorithm to translate the metric into a reasonable time period as shown below. Because the value is based on the plant canopy temperature, any control logic is self-correcting in that if too little water is applied during the Automatic Mode, the subsequent measurement of time of canopy temperature above biological optimum will be a greater number, which will increase the amount of irrigation time for the next period.

In one embodiment, in the Hybrid Mode, the apparatus splits an irrigation interval (for example 24 hours) into two periods. One period would be a Timer Mode and the other period would be Automatic Mode.

Irrigation Timing Algorithms:
Automatic Irrigation Time per zone (T_{AI(1)}). T_{AI(1)}=Stress Time*Irrigation Factor
Given a Stress Time of 210 minutes for zone 1 and an Irrigation Factor of 3.33; T_{AI(1)}=63 minutes

An additional logical algorithm can be added to automatically adjust the Irrigation Factor to make it self-correcting such that irrigation times that continue to increase while daily high temperatures are not increasing suggests that the irrigation times are set too low. Likewise, if irrigation times are decreasing while daily high temperatures are increasing suggests that irrigation times are set too high. Therefore, the following equation allows for the automatic correction of irrigation times by the adjustment of the Irrigation Factor (IF):

Irrigation Factor (New): IFNEW=IF0+TF0/TF(−5)

Where:

IF₀=Irrigation Factor at today

TF=Time Factor=3-day high temp average/3-day Irrigation Time average

TF₀=Time Factor at today

TF₍₋₅₎=Time Factor five days ago

If: IF₀=3.33

TF₀=64.58

TF₍₋₅₎=60.42

Then: IF_{NEW}=3.56

Additionally, a minimum and maximum time per irrigation interval can be used to adjust the Irrigation Factor. For instance, if a minimum irrigation time per day of 20 hours is desired and a maximum irrigation time per day of 23 hours is also desired, then irrigation times can be calculated with the current Irrigation Factor and if the total irrigation times for all zones added together is not within the min/max range, the Irrigation Factor can be altered by the correct percentage to reach a min/max point.

The computerized nature of the entire system lends itself to a plethora of customization options. One example is the Varying Zonal Irrigation schedule: In one embodiment, the SmartDrip™ controller can be set to select the zone with the highest automatic irrigation time to be the one that is irrigated first, the zone with the second highest automatic irrigation time to the irrigated second and so on until all zones have been irrigated.

In another embodiment, the system can vary irrigation by weather forecast. To do so an additional adjustment is made to the automatic irrigation time by allowing a modification based on multiplying the automatic irrigation time by a factor based on forecasted high temperature, the higher the forecasted high temperature, the greater the factor, the cooler the forecasted high temperature, the lesser the factor. The factor should be set to a minimum range of approximately 0.9 and a maximum range of 1.1. Also, the forecasted high temperature adjustment can be made on a three or five day forecast as well as a single day forecast.

Turning back to FIG. 36, in one embodiment, once the central computer has correlated the collected data with the algorithms and parameters, the computer formulates a YES or NO decision whether to irrigate, or apply a topical application, or produce a yield prediction. In one embodiment, this decision may be wirelessly transmitted to the grower via any known method of wireless transmission including cell phone text message, email, pager alert, SMS (short message service), MMS (multimedia message service) radio frequency, World Wide Web, mobile Web or others. In one embodiment, the grower may then execute the decision by manually turning the irrigation system on or off or by logging onto the computer and remotely turning the irrigation system on or off. In one embodiment, the grower may also choose to have his system automated so that the irrigation decision is transmitted to the base station 34 for execution. In one embodiment, the field base station 34 is wired into the irrigation system 38 and can automatically start or stop the irrigation by opening or closing the valves in the specified zones.

In one embodiment, simultaneously with the computer's transmission of a control command to the field based controller, the computer may also send an alert to the grower, advising of the irrigation change that has been made. The grower may choose to remotely override the change.

In one embodiment, the end user may request “quiet times” during which the computer does not send him alerts.

In one embodiment, the central computer is capable of storing the data and acting as the web server 36 in such a manner that the data and outputs of the algorithms can be used for later viewing and further analysis by an end user.

In some embodiments, the field base station 34 may also have settings so the grower can remotely instruct it to perform tasks such as adjust rates of water or a topical application, activate the stop or start relay for an electric irrigation well, or activate solenoids to flush the filtration system.

The disclosed method and system enables the grower to assess and fully control his crops from the comfort of his office or the mobility of his cell phone.

A wide variety of data parameters may be programmed into the central computer as desired. For example, in one embodiment, when there is a significant amount of rainfall detected at the field, the central computer will send a signal to the field based controller to stop irrigation. Contemporaneously, the central computer will send a message to the end user, stating that a certain amount of rain has been measured and that the irrigation has been stopped. An end user will have the option to override the automatic signal sent to the field based controller if desired.

In another embodiment, the data collection devices will have the capability to collect data to help predict predicted environmental variables (weather changes). The algorithms will use the data to correlate how much water the plant needs to maintain its optimum growth, taking into account the plant's canopy temperature and the environmental and predicted environmental variables. For example, if the plant were somewhat thermal stressed, however, the system predicted low temperatures and a high chance for rainfall in the next twelve hours, it would be wasteful to run the irrigation system. The algorithms might generate the decision to delay irrigation under the circumstances.

Some growers may want the software to take note of commodities market changes and correlate those price ranges into the decision of whether to irrigate. Other growers may want to program certain critical life cycle stages, such as germination or blooming, of the plant's growth so that the computer takes these into account when making the irrigation decision.

There are certain times in a plant's life cycle where it may be beneficial for the plant to receive more or less water. For example, during germination, a plant may benefit from additional water. If the projected weather forecast includes rain, or even if it does not, it may be prudent to avoid watering, even if the plant exhibits stress. There are times when a grower may decide not to water, even if direct biological data reflects plant stress, due to changes in the market or changes in his projected crop income. All of these parameters and more can be programmed into the existing computer software to help tweak the irrigation decision depending on the grower's strategy.

In some states, there are periods of time when growers are not allowed to water, or are only allowed to water certain zones. Knowing which zones are in most need of water based on the plant type, plant life stage, and plant stress would help a grower to determine which zones to turn off when required to limit water usage. In conjunction with the collected biological and environmental data, a sound watering decision is reached. Some growers may want to monitor energy costs and correlate those numbers as additional criteria for determining whether to irrigate.

Another beneficial data measurement easily incorporated into this system is the pressures and flows of an irrigation system. In an embodiment, where the field base station is a transceiver, the controller may receive data from sensors capable of measuring pressure changes in the irrigation system. Changes in pressure outside specified parameters could trigger an alarm delivered from the field base station (via two way radio) to the central computer and from the central computer, wirelessly to the end user in the form of cell phone text message, email or other wireless means.

The hardware and software platform designed and used for the disclosed method and system are adaptable to many types of sensors, for example even analog sensors. The platform can define data from multiple types of sources. The benefit of this specially designed platform is that the operator need not change hardware or software in order to read new types of data. The platform has the ability to easily collect and interpret various types of known and unknown data. The system has an efficient protocol and can be run with very little memory. This in turn reduces cost.

In one embodiment, the disclosed system and method can be used for plant variety characterization. In one embodiment, the system and method can monitor a plant variety to determine how it performs in response to stress from various causes of plant stress. In one embodiment, the method and systems can be used to compare one variety to another, for example, to determine which variety has preferable traits which allow for better crop condition or yield in the presence of stress. If two varieties differ by a known trait, the disclosed system and methods can be used to determine how the trait influences crop condition or yield in the presence of stress. Traits which may be identified as significant by the system and method include, but are not limited to, plant height, leaf thickness, maturity (early or late), drought tolerance, pest resistance, and disease resistance. In one embodiment, any morphological or biochemical trait may be identified as significant. In another embodiment, the plant variety can be characterized for its response to topical applications.

In one embodiment, the disclosed system and method can be used to generate a management decision with regard to any number of plants, including, but not limited to corn, soybeans, cotton, grapes, wheat, fruit trees, vegetable plants, grains, and vine crops.

The following examples are provided to further illustrate the present invention and are not intended to limit the invention beyond the limitations set forth in the appended claims.

### EXAMPLES

### Example 1

### Preparation of the Temperature Gradient Table

One embodiment of the Temperature Gradient Table comprises a two foot by 3 foot plate of aluminum. A water substitute of ethylene glycol is used but any number of thermal fluids and even water will work well for this type of a setup. A water bath was set at one end of the table, with in and out connectors and tubes attached so that the water from the bath circulated through the column drilled at one end of the table, then back through to the water bath. The other side of the table was fitted with a second water bath. This second water bath contained water that was set at a higher temperature circulating through the other drilled column on the table. This created a temperature gradient over the length of the table. For each separate experimental run, the gradient system was allowed to acclimate for at least 30 minutes prior to placement of the samples on the gradient table. Gradient table temperatures were monitored during the experimental procedures to ensure accuracy.

### Example 2

### Preparation of Leaf Samples of the Rice Cultivars

The experiment described in the following examples was a blind analysis of 24 different rice cultivars growing in an outdoor test area. Rice breeders grew the various cultivars in 24 individual test plots. The rice breeders provided the samples of plant material from the rice cultivars to the inventors at the testing location without any indication of the rice cultivar name, its relative growth temperature optimum, or any other identifying information.

Plant material from the 24 above-mentioned cultivars in the research plot were collected over June and July of 2010. Several rice plants from a specific plot were removed from the soil in the afternoon and packaged for overnight transport to the laboratory using the following procedure. Approximately six plants were collected with a small amount of soil left on the roots. These plants were placed in a plastic bag along with a water-soaked piece of filter paper measuring about 8 square inches. The plastic bag was sealed and placed in a Styrofoam container with a freeze pack placed next to the plastic bag. The Styrofoam container was placed in the cardboard box for overnight shipment to the OPCT testing location.

When the plant material was received at the testing location, the plant material was immediately placed into a plastic container containing approximately 0.5 inches of water in order to cover a portion of the roots. Leaf samples of approximately 0.5×0.5 inches were cut from the leaves of the sample plants using a sharp razor blade.

The prepared leaf samples were placed on 3 mm thick pre-wetted filter paper lying on top of the temperature plate. Five leaf samples were placed from front to back at each of nine different temperatures along the gradient. Leaf samples having visible defects such as discoloration, curling, cupping, or other defects were discarded. Additional water was added to the filter paper until it was saturated. A sheet of CO₂ permeable plastic wrap (such as GLAD WRAP plastic wrap) was then placed over the samples. A rubber wallpaper roller was then used to gently press excess air from underneath the plastic wrap and to gently flatten the samples against the moist filter paper.

### Example 3

Exposing the Plant Leaf Samples with Light Prior to the Fluorescence Measurement

The leaf samples placed on the temperature gradient plate were then treated to a 15 minute “light charging” period (also termed “light soak” or “light adaption”) in preparation for the subsequent Chlorophyll a fluorescence testing. The light source was photosynthetic light emitting 340 micromoles m⁻² sec⁻¹. Six 4-foot long fluorescence light tubes were placed six inches above the temperature gradient plate containing the prepared leaf samples. At the end of the fifteen-minute period of light exposure the light exposure was measured, the light was turned off and the remainder of the test was performed in the dark.

### Example 4

### Fluorometer Measurement of the Leaf Samples

Immediately after the light exposure period described in Example 3 was complete, the chlorophyll a fluorescence testing began. An OS1-P Portable Modulated Chlorophyll Fluorometer (Opti-Science; Hudson, N.H., USA) was used for measurement, following the directions provided by the manufacturer. In order to maintain accuracy of the timing of the fluorescence sampling, the measurement readings were taken in a specific order, which was repeated for each run. The sensor was placed directly on the sample and the “test run” button was pushed. A light flashed, indicating that the reading was taken, and the fluorometer was moved on to the next sample. The fluorometer output data provided the values Fₘ (maximum fluorescence from a light-adapted leaf) and Fₒ (minimum fluorescence from a light-adapted leaf). These values were used to create the ratio Fᵥ/Fₒ where Fᵥ is Fₘ−Fₒ. Because the leaf samples were placed at each of nine different locations on the temperature gradient plate, the readings provided Fᵥ/Fₒ values for nine different temperatures. The fluorometer used in this example uses the same wavelength as the saturation light at the start of the test which is a full spectrum light. The intensity can be modified on the instrument and generally will be changed to match the leaf material. The current fluorometer has a calibration setting developed by the manufacturer for these settings.

The sampling process was repeated every five minutes to observe the chlorophyll a fluorescence values over a period of thirty minutes. This time period is determined by the plant's photosystem relaxation period, generally around 2.5 minutes. The time period can be shortened or lengthened based on the plant material. The process allowed the leaf samples to return to a relaxed state within Photosystem II. Longer periods of time can be used as long as the relaxations state is met. The method provided a steady-state condition of each leaf sample at its test temperature according to its location on the temperature gradient table.

### Example 5

### Calculations, Statistical Analysis, and Interpretation of Results

The data from the fluorescence measurement in Example 4 was downloaded from the fluorometer to the computer. The data was imported to an Excel spreadsheet for processing with a specific macro designed to calculate the Fᵥ/Fₒ. Separate line graphs of Fᵥ/Fₒ corresponding to each of the nine temperatures tested for each of the 24 test plot cultivars were prepared using the Excel charting function, with the graph created by setting to Gallery; linear; line; then setting the X and Y parameters as needed: X=minutes into test; Y=each temperature tested. The resulting line graphs are shown in FIG. 4 through FIG. 27.

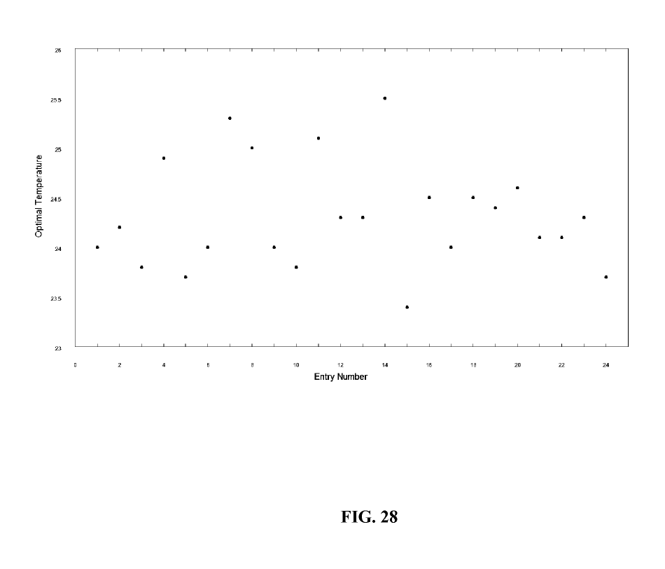

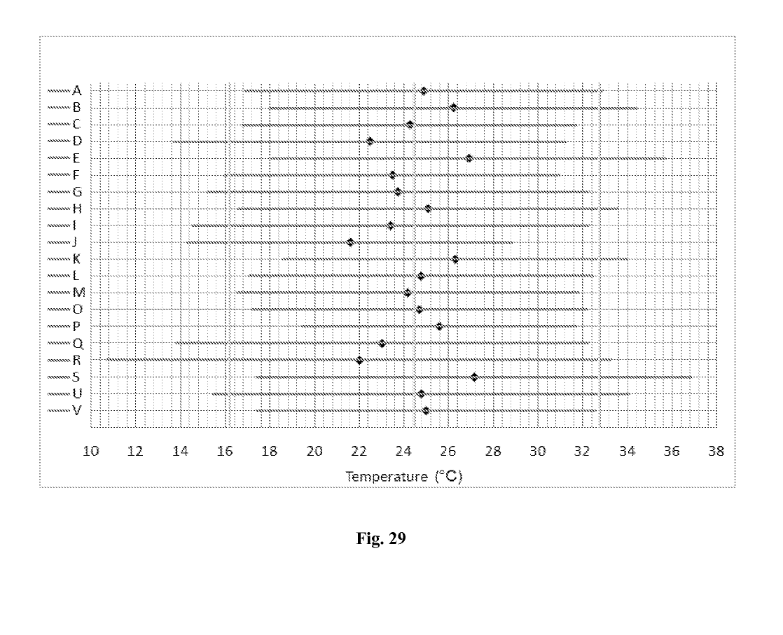

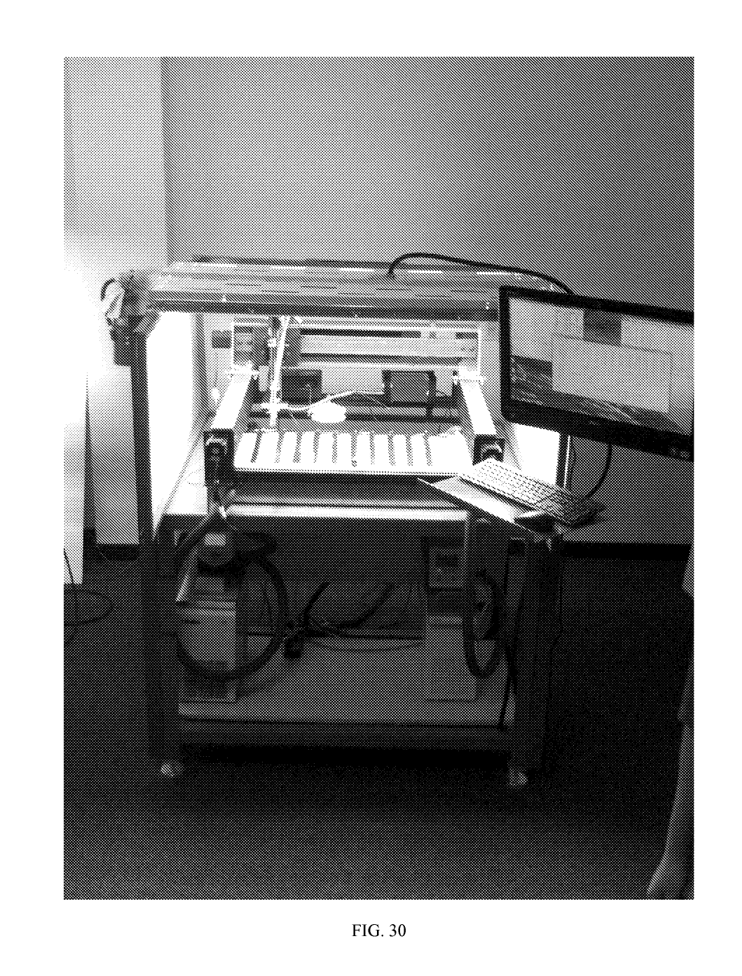

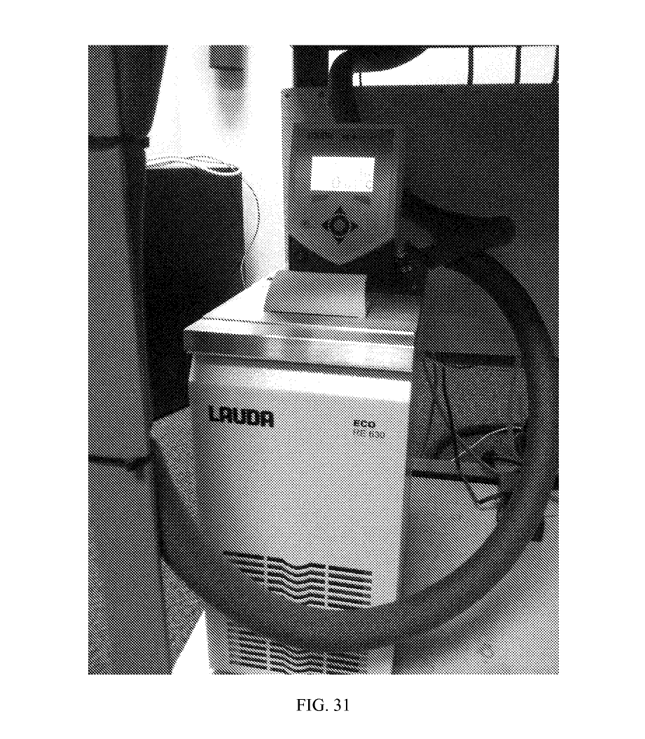

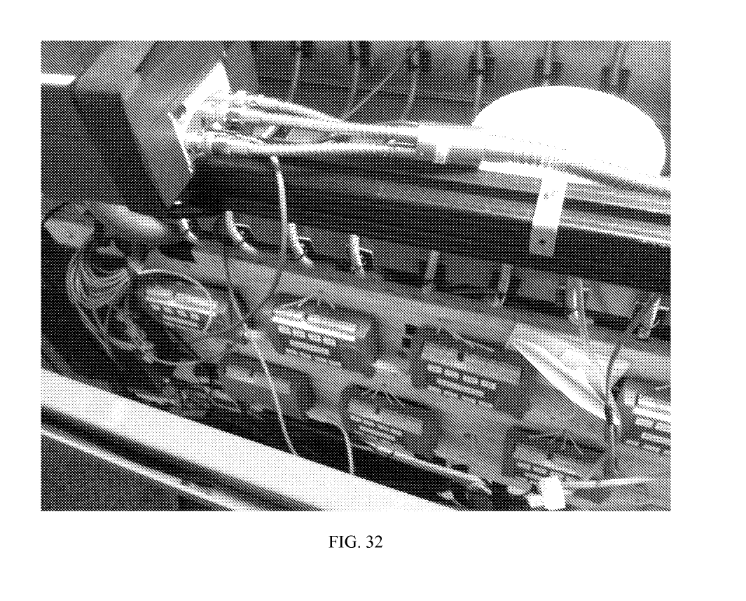

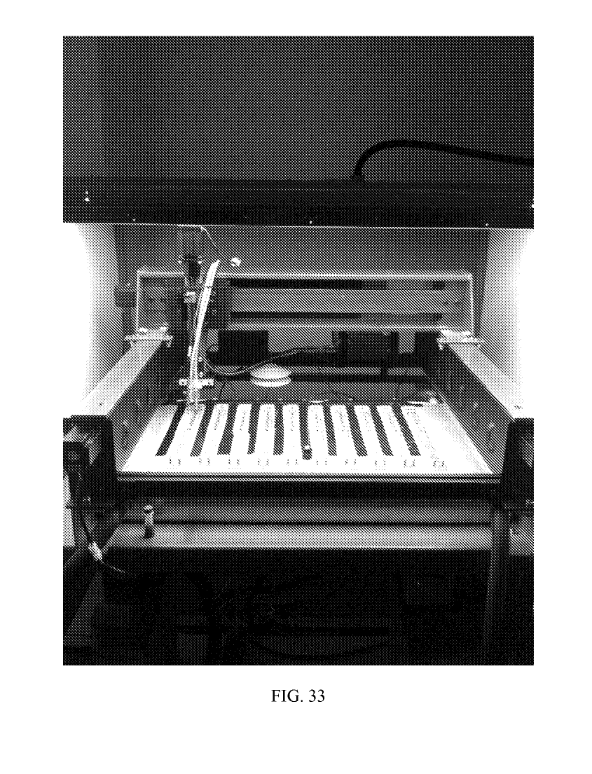

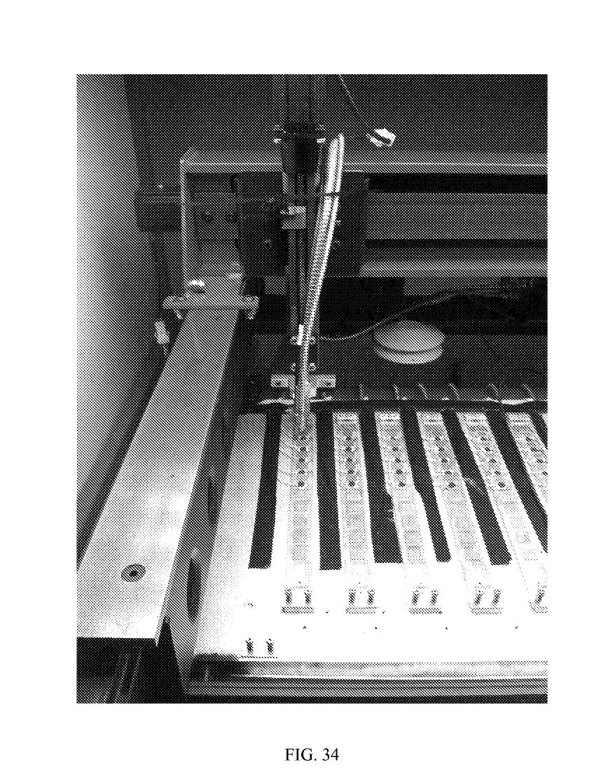

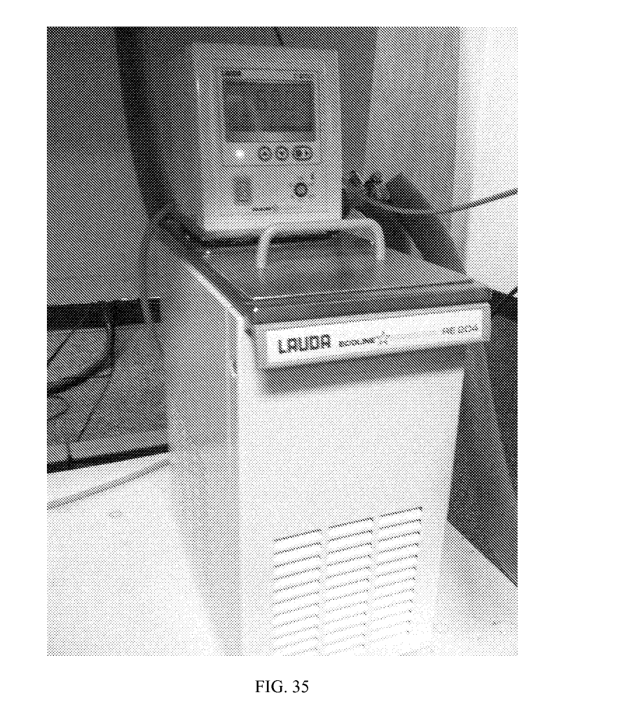

Each of the graphs plots Fᵥ/Fₒ over a period of 30 minutes for the tested cultivar at a specific temperature on the temperature gradient plate. Once the temperature response curves were created, the optimal plant canopy temperature response curves were chosen based on an evaluation of the data combined with the following three characteristics: 1) a quick rise of Fᵥ/Fₒ in the first five minutes; 2) a high Fᵥ/Fₒ value at 5 minutes; and 3) a flat slope from 5 minutes to 30 minutes. This evaluation method followed the general method of Burke, J. J. (1990); Plant Physiol. 93:652-656). Using this process, an optimum canopy temperature was selected for each cultivar, as shown below in Table 2. The range in final optimum canopy temperature determination for the 24 tested rice cultivars was from 23.4° C. to 25.5° C., with an average of 24.3° C. A summary of the optimal plant canopy temperature data for the 24 cultivars is also represented as a dot plot, as shown in FIG. 28.

TABLE 3
Determination of Optimal Plant Canopy
Temperature for 24 Rice Cultivars

| | Optimal Plant Canopy |
|---|---|
| Rice Cultivar | Temperature |
| Plot 1 | 24.0° C. |
| Plot 2 | 24.2° C. |
| Plot 3 | 23.8° C. |
| Plot 4 | 24.9° C. |
| Plot 5 | 23.7° C. |
| Plot 6 | 24.0° C. |
| Plot 7 | 25.3° C. |
| Plot 8 | 26.0° C. |
| Plot 9 | 24.0° C. |
| Plot 10 | 23.8° C. |
| Plot 11 | 25.1° C. |
| Plot 12 | 24.3° C. |
| Plot 13 | 24.3° C. |
| Plot 14 | 25.5° C. |
| Plot 15 | 23.4° C. |
| Plot 16 | 24.5° C. |
| Plot 17 | 24.0° C. |
| Plot 18 | 24.5° C. |
| Plot 19 | 24.4° C. |
| Plot 20 | 24.6° C. |
| Plot 21 | 24.1° C. |
| Plot 22 | 24.1° C. |
| Plot 23 | 24.3° C. |
| Plot 24 | 23.7° C. |

### Example 6

Confirmation of Results by Correlation with the Optimum Canopy Temperature Results of Outdoor Grown Plants of the Same Cultivars

To confirm whether the indoor OPCT determinations for the rice cultivars correlated with outdoor growth data, the OPCT findings were then reviewed with the breeders who provided the plant samples. The findings provided by the leaf OPCT test correlated closely with the breeders' temperature expectations for each of the tested cultivars.

### Example 7

The experiment described in the following example was a blind analysis of 20 different cultivars of a single monocot specie of plant grown in an outdoor test area. Cultivars were grown in individual test plots. Trial managers provided the samples of plant material to the inventors at the testing location without providing any indication of name, genetic characteristics or any other identifying information.

Plant materials from the 20 above-mentioned cultivars in the research plot were collected over May and July of 2011. Several plants from a specific plot were removed from the soil in the afternoon and packaged for overnight transport to the laboratory using the following procedure. Approximately three plants were collected with a small amount of soil left on the roots. These plants were placed in a plastic bag along with a water-soaked piece of filter paper measuring about 8 square inches. The plastic bag was sealed and placed in a Styrofoam container with a freeze pack placed next to the plastic bag. The Styrofoam container was placed in the cardboard box for overnight shipment to the OPCT testing location. The process was repeated for every cultivar over six defined growth or developmental stages. These stages were Green Ring, Critical Temperature Start, Critical Temperature End, Visible Boot, One Percent Heading and Fifty Percent Heading.

When the plant material was received at the testing location, the plant material was immediately placed into a plastic container containing approximately 0.5 inches of water in order to cover a portion of the roots. Leaf samples of approximately 0.5 inch diameter were cut from the leaves of the sample plants using a boring instrument.

The prepared leaf samples were placed on 3 mm thick pre-wetted filter paper lying on top of each sample pedestal on the thermal plate. Five leaf samples were placed on each sample plate and across all ten of the sample plates. Leaf samples having visible defects such as discoloration, curling, cupping, or other defects were discarded.

The rest of the procedure follows the experimental procedure outlined in examples 3 and 4.

### Example 8

The following table provides specific examples of components and their commercial availability for one embodiment of the invention similar to that depicted in the drawing of FIG. 1.

TABLE 4
Specific examples of components and suppliers

| Component | Manufacturer or Supplier | Model |
|---|---|---|
| Equipment Stand | McMaster Carr | Hercules Steel Machine Table |
| Thermal Plate - New | Custom Design by Smartfield | Custom Build by AbleTech |
| Thermal Plate - Modified | Custom Design by Smartfield | Custom Build by AbleTech |
| Sample Plates - New | Custom Design by Smartfield | Custom Build by AbleTech |
| Sample Plates - Modified | Custom Design by Smartfield | Custom Build by AbleTech |
| Sample Clamps | Custom Design by Smartfield | Custom Build by AbleTech |
| CNC | Torchmate | 2 × 2 |
| Fluorometer | Opti-Science | OS1P |
| Cold Water Circulator | Lauda Brinkmann | RE630 |
| Hot Water Circulator | Lauda Brinkmann | RE204 and E4 |
| Circulator Fluid and Hoses | Standard Off the Shelf Home | |
| | Depot supplies | |
| Tool Head Clamp | Custom Design by Smartfield | Custom Build by AbleTech |
| Data Loggers | Measuring Computing Corp | USB-Temp |
| Thermistors | Omega Engineering | ON-409 |
| PPF Sensor (Light Intensity | Apogee Instruments | Quantum Meter MQ-200 |
| Sensor) | | |
| RH Pod | Smartfield, INC | RH Pod |
| Overhanging Light Source | Philips | T5HO-FBF654HO-UNV |
| Power | Standard off the Shelf | |
| | Electronics | |
| Computer | Standard off the Shelf | |
| | Electronics | |
| USB Connections | Standard off the Shelf | |
| | Electronics | |
| Light Shielding for Tables | Cut Lexan from Home Depot | |

### Example 9

The following example contains an exemplary protocol for using the apparatus.

Equipment:

1—Fluorometer—Opti-Science (model ° SIP)
1—Custom clamp to attach fluorometer to CNC
2—Water Circulators—Lauda Brinkmann (model Ecoline RE204)
1—CNC (X Y table with Z axis)—Torchmate (model 2×2)
2—Data Collection Boxes—MicroDAQ (model 8 Channel Thermocouple DAQ Module)
16—Thermistors—Omega Engineering (model HSTH-44031-80 Hermetic Flex Thermistor Sensor)
2—Table Stand—McMaster-Carr (model Hercules Steel Machine Table—48″×30″×36″)
1—Light Intensity Sensor—Apogee (model Quantum Flux Sensor)

### 20 Liters—Ethylene Glycol Fluid—VWR

1—Bar Code Scanner—unspecified
2—Thermal Plates with mounting equipment—AbleTech (custom build)
20—Sample Plates with cover assemblies—AbleTech (custom build)

### 1—Box of Glad Wrap

1—Package of Gel Blot Paper—Whatmann (model GB004)

### 1—Computer

1—Light set up with photosynthetic light bulbs (must be capable of generating over 300 μmols/m̂2)
Relative Humidity and Ambient Sensor—Smartfield (model RH pod)

Assembly of Equipment:
1. Place table stand such that it is clear of all obstructions on all sides, install feet and level the table.
2. Assembly thermal plate and mounting equipment.
3. Place thermal plate assembly on table stand and secure.
4. Repeat steps 1 through 3 for the second table stand and plate assembly.
5. Place water circulators between two table set ups.
6. Attach hoses from the circulators to both plates, check for leaks (its best to check for leaks using water before adding the Ethylene Glycol).
7. Assembly CNC
8. Place CNC on top of one of the plate assemblies and secure with bolts (this will be the Run table)
9. Connect all thermistors to the data collection boxes and secure the data collection boxes to the table stand and run the thermistors into position on both the Run and Prep plate.
10. Place the body of the light intensity sensor near the computer's final location and run the sensor to the middle of the thermal plate area and secure to the plate.
11. Hang light apparatus above table as far from the plate that still generates sufficient light intensity. (May need to install an option to move the light if it blocks the path of the CNC)
12. Attach the fluorometer head to the z-axis of the CNC, connect the head back into the fluorometer.
13. Connect the USB cables from the data collection boxes, light intensity sensor, the CNC, the bar code scanner, and the fluorometer to the computer.

Set Up:

Before a test can be started the following steps must be followed:
1. Check the fluid levels of both of the water circulators, if below recommended manufacturer levels then add more fluid, if fluid appears dirty, change immediately
2. If fluid is changed, the units are left off for several hours, or it is the first time that the units have been turned on, a period of at least 24 hours must precede any testing.
3. Make adjustments to the temperature range on the chillers based on the plant material being testing. (a 25 degree range centered around the expected optimal temperature must be met for the test to be successful)
4. Make a test run of the CNC machine to make sure equipment is working properly, check CNC code to make sure that it drops the z-axis at every pedestals' center point.
5. Check battery voltage and memory capacity on the fluorometer, memory should be cleared before start of testing schedule and battery should be at full power.
6. Check sample plates to make sure they are perfectly flat, if not they need to be replaced.
7. Prepare 20 to 40 sample plate covers with Glad Wrap inserts. (Glad Wrap needs to be pulled tight).
8. Ensure all measuring instruments are measuring correctly.
9. Cut Gel Blot paper into ½ inch squares.
10. Place sample plates with plate covers on the thermal plate at least 24 hours before testing, this will allow them to reach the same temperature as the thermal plate.
11. Run the computer program for the automation of the data collection.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A apparatus for determining the optimal plant canopy temperature of a plant comprising:
a temperature gradient table;
a thermal plate located on the upper surface of the temperature gradient table;
a temperature gradient mechanism connected to the thermal plate;
a temperature sensor connected to the thermal plate;
a mobile mechanism;
a fluorometer;
a measurement probe operably connected to the fluorometer and the mobile mechanism such that the mobile mechanism can move the measurement probe into multiple positions above the thermal plate; and
a computer operably linked to the temperature sensor, the fluorometer and the mobile mechanism.

2. The apparatus of claim 1, wherein the temperature gradient mechanism comprises a first and second channel on opposite sides of the thermal plate suitable to pass liquids through or along the thermal plate;
a cool thermal fluid inlet at one end of the first channel;
a cool thermal fluid outlet at the second end of the first channel;
a hot thermal fluid inlet at one end of the second channel;
a hot thermal fluid outlet at the second end of the second channel;
a cold liquid circulator connected to the cool thermal fluid inlet; and
a hot liquid circulator connected to the hot thermal fluid inlet.

3. The apparatus of claim 2, further comprising one or more additional channels.

4. The apparatus of claim 1, wherein the temperature gradient mechanism comprises a Peltier device.

5. The apparatus of claim 1, wherein the temperature gradient mechanism comprises a liquid immersion bath, wherein the bottom layer of the thermal plate is in contact with the liquid.

6. The apparatus of claim 1, wherein a pedestal for holding a sample is located on the thermal plate and the temperature sensor is connected to the pedestal.

7. The apparatus of claim 1, wherein the computer comprises instructions for recording data from the fluorometer and temperature sensor, and positional information of the measurement probe.

8. The apparatus of claim 1 wherein the mobile mechanism is a robotic arm.

9. The apparatus of claim 1, wherein the computer comprises instructions for moving the mobile mechanism so that the measurement probe is positioned above a position on the thermal plate.

10. The apparatus of claim 9, wherein the instructions move the mobile mechanism at specific time intervals.

11. The apparatus of claim 6, wherein there are multiple pedestals.

12. The apparatus of claim 6, wherein the pedestal is located on a removable fixture plate which is attached to the thermal plate.

13. The apparatus of claim 12, wherein multiple pedestals are located on the removable fixture plate.

14. The apparatus of claim 1, further comprising a light source.

15. The apparatus of claim 1, further comprising a light intensity sensor.

16. The apparatus of claim 1, wherein the mobile mechanism can move the measurement probe in x, y and z axes.

17. A method of collecting data comprising:
a. obtaining leaf material of a plant;
b. preparing leaf samples from said leaf material;
c. placing the leaf samples on a temperature gradient surface so that the leaf samples will be at various temperatures;
d. exposing the leaf samples to light for a period of time;
e. measuring the intensity of the light source;
f. measuring the fluorescence of the leaf samples with a probe;
g. measuring the temperature of each leaf sample; and
h. recording the position of the probe.

18. The method of claim 17, wherein the method is performed with the apparatus of claim 1.

19. The method of claim 17, wherein the light exposure is from between 1 to 120 minutes.

20. The method of claim 17, wherein one or more individual plants are tested.

21. The method of claim 20, wherein the one or more individual plants to be tested differ in the presence of at least one gene.

22. The method of claim 20, wherein the one or more individual plants to be tested differ in the presence or absence of at least one protein.

23. The method of claim 20, wherein one or more lines, hybrids or varieties of a single plant species are tested.

24. The method of claim 20, wherein plants from one or more species are tested.

25. The method of claim 17, wherein the plant is selected from the group consisting of a non-vascular plant, a vascular plant, a shrub, a seedling, a grass variety, a tree, a bush, and a vine.

26. The method of claim 17, wherein the plant is a monocotyledonous plant or a dicotyledonous plant.

27. The method of claim 17, wherein the plant is a crop plant.

28. The method of claim 27, wherein said crop is selected from a food crop, a biofuel crop, and a commercial crop.
